(19) United States
(12) Patent Application Publication
(10) Pub. No.: US 2026/0209123 A1
(43) Pub. Date: Jul. 23, 2026

(54) FORMULATION FOR THE PREPARATION OF OPTICAL METAL OXIDE LAYERS

(71) Applicants: Merck Patent GmbH, Darmstadt (DE); B.G. Negev Technologies and Applications Ltd., Beer-Sheva (IL)

(72) Inventors: Henning Seim, Darmstadt (DE); Oleg Chashchikhin, Petah Tikva (IL); Nina Lidich, Jerusalem (IL); Hagai Arbell, MEVASERET ZION (IL); Amir Holtzman, REHOVOT (IL); Andreas Berkefeld, Darmstadt (DE); Ira Weinstock, Ofakim (IL); Nitai Leffler, Kibbutz Ein Hashlosha (IL); Roy Schreiber, REHOVOT (IL)

(21) Appl. No.: 19/140,272

(22) PCT Filed: Dec. 19, 2023
(86) PCT No.: PCT/EP2023/086581

§ 371 Date: Jun. 17, 2025

Related U.S. Application Data
(60) Provisional application No. 63/477,311, filed on Dec. 27, 2022.
(60) Provisional application No. 63/505,206, filed on May 31, 2023.

(51) Int. Cl. C04B 35/495; C04B 35/622; C04B 35/634; G02B 27/01

(52) U.S. Cl. CPC C04B 35/495; C04B 35/62222; C04B 35/63488; C04B 2235/3232; C04B 2235/3234; C04B 2235/3255; C04B 2235/326; C04B 2235/3293; C04B 2235/5454; G02B 27/0101

(57) ABSTRACT

The present invention relates to a formulation for preparing an optical metal oxide layer, the formulation comprising polyoxometalates (POMs) complexed to metal oxide nanoparticles (NPs); a method for preparing an optical metal oxide layer using said formulation; and an optical device comprising said optical metal oxide layer.

### RELATED APPLICATIONS

The present application is a National Stage Entry under 35 U.S.C. § 371 of International Application No. PCT/EP2023/086581 filed Dec. 19, 2023, which claims the benefit of priority of U.S. Provisional Application No. 63/505,206, filed May 31, 2023, and U.S. Provisional Application No. 63/477,311, filed Dec. 27, 2022, the contents of each of which are incorporated herein by reference in their entireties.

### FIELD OF THE INVENTION

The present invention relates to a formulation for preparing an optical metal oxide layer comprising polyoxometalates (POMs) complexed to metal oxide nanoparticles (NPs), a method for preparing an optical metal oxide layer and an optical device comprising an optical metal oxide layer. Said formulation and method according to the invention are particularly suitable for the preparation of metal oxide optical layers for optical applications or devices such as, for examples, diffractive gratings for augmented reality (AR) and/or virtual reality (VR) devices. The metal oxide layers show (a) favorable optical properties such as high refractive index (RI) or >1.7, preferably >2.0, at wavelengths of ≤520 nm and/or low absorption of <0.1% at 480 nm, and/or low degree of haze formation; (b) favorable mechanical properties such as low shrinkage; (c) favorable coating properties such as dense layer and flat surface structure; and/or (d) favorable filling properties such as homogeneous filling of topographical features on patterned substrates.

The embodiments of the present invention allow the preparation of optical metal oxide layers on the surface of both patterned and non-patterned substrates. The metal oxide layer may form various structures such as, for example, layers covering a surface of a non-patterned substrate and/or fillings covering topographical features such as e.g. gaps on the surface of a patterned substrate, thereby providing highly refractive optical structures. In particular, the embodiments of the present invention allow the preparation of advanced optical gap filling with low overburden, thus enabling an easy and cost efficient mass production of complex optical devices by avoiding typical problems occurring when layer deposition or gap filling is performed by physical vapor deposition (PVD) or chemical vapor deposition (CVD) techniques such as, for example, incomplete or excessive gap filling due to unfavorable deposition and layer growth characteristics such as, for example, decreased or increased deposition or growth rates at corners and edges.

The embodiments of the present invention are particularly suitable for the preparation of optical metal oxide layers having high refractive index for optical devices such as, for example, for diffractive gratings in AR and/or VR devices.

Finally, the present invention provides an optical device, preferably an AR and/or VR device, comprising an optical metal oxide layer, which is obtainable by the method according to the present invention or which is prepared by using the formulation according to the present invention.

### BACKGROUND OF THE INVENTION

Leading edge optical devices typically include optical gratings made from composite materials having a substrate as a support and complex and interlaced patterns thereon, the patterns being made up of different layers or stacks of layers. Usually, the creation of such complex and interlaced patterns demands for structuring processes, which become increasingly challenging with decreasing size of structural dimensions to be prepared.

In addition to a wide range of possible uses in various fields of application, such as in spectrometers or in optical storage systems (CD, DVD, etc.), diffractive gratings are the core components of so-called XR devices, mostly glasses. In this context, R stands for the term reality and X denotes different attributes such as, for example, virtual, augmented, mixed and so forth. Hence, diffractive gratings form part of the core of the so-called optical engine in XR devices, specifically in augmented reality and mixed reality glasses. Virtual reality glasses, when built as a head mounted display, are often composed of a conventional liquid crystal (LC) organic light emitting diode (OLED) display being embedded in the device, and thus do not necessarily require diffractive gratings. In contrast, augmented and mixed reality glasses are designed that way to enable consumers to obtain visual impressions of their environment, at its best as if they would not wear any glasses at all. However, they also make it possible to provide and serve digital information and to also project it into the field of vision of individuals. Additional digital information is gathered from recognizing and analyzing the environment, which the individual inspects or currently takes a look at. In order to convey and project supporting digital information into the eyes of an individual, the augmented or mixed reality glasses are equipped with an information supply unit, which is coupled to an optical waveguide system that transports the optically coded supporting information through it directly to the lens of the glasses. Here, the information passes a diffractive grating, which couples the incident light into the lens and splits it according to its angular information and its spectral bands by diffraction. After incoupling of the light, the lens serves as waveguide enabling transport of the light to and into the pupil of an individual. The location of light incoupling is independent of any preferred position and thus of the implication of technical needs. The direction of traversal of light within the lenses is determined by the diffractive grating diffracting or splitting the light. At certain positions in the lens, a second and a third diffractive grating serves for changing the direction of light traversal and thereby enforcing the light to be projected into a pupil of the user. The light traversal in the glasses is accomplished by total internal reflection (TIR) of the light, thus bouncing several times between the glass interfaces until reaching another diffractive grating, which changes the internal TIR direction of the light (see FIG. 2). The second and third grating are geometrically aligned in different directions with respect to the first and incoupling grating, e. g. by a certain angular distortion of the longitudinal axis, thus allowing to change the direction of propagation of totally internally reflected light. Needless to say, the lens itself or the material of which lenses are made of shall not be absorbing. Otherwise, the supportive information never reaches the pupil of the user or only with strongly depleted light intensity. The process works regardless of the use of reflection or transmission gratings. Usually, the lenses are equipped with both types of gratings to properly guide the light. It should also be mentioned that there are differences in the optical performance of reflection and transmission gratings, which, however, are of no further interest in the context of the current invention. The basic structure of the gratings is very similar, which is more important at this point.

Nevertheless, there are different designs and structures such as surface relief (SR) or volume phase holographic (VPH) gratings to achieve waveguide. Both types are very similar in appearance. In the simplest case, the gratings are somehow mounted onto the surface of a waveguiding material, here the lens. The grating itself is composed of an array of fine structures, mostly trenches of a first material type Material 01 with a refractive index RI 01, however, not limited thereto. The geometrical shape of the trenches may be manifold, from rectangular, over V-shaped trenches, U-shaped and there like. The width, including structures with different widths, the geometrical form of the trenches, their pitch as well as their depth, including different depths, are specially designed to influence the diffraction pattern of the incident light to be diffracted.

In case of SR gratings (SRGs), the trenches or structures of a first material type (Material 01) having a refractive index (RI 01) are filled by a second material type (Material 02) having a refractive index (RI 02), wherein RI 02 is incrementally different from RI 01 (see FIGS. 1 and 3). For the sake of completeness, it should be mentioned that Material 01 or Material 02 may be composed of a stack of structured layers, each containing a different material composition with different refractive index, stacked on top of each other, thereby forming Material 01 or Material 02 having an effective or graded refractive index RI 01 or RI 02, respectively. Incidentally, the (effective or graded) refractive indices RI 01 and RI 02 depend on the refractive index of the waveguide or the lens from which the glasses are made of. If a glass lens with high refractive index (n03>1.46) is used, the (effective or graded) refractive indices of Material 01 and Material 02 are considered to be higher than that of the lens itself, whereby a RI value of 2.0 can be reached and exceeded. High performance gratings, especially those of SR-type, may be manufactured using standard lithography and deposition techniques known from micro-fabrication such as, for example, the manufacturing of integrated circuits.

Such standard techniques typically include physical vapor deposition (PVD) or chemical vapor deposition (CVD) processes and often suffer from incomplete gap filling due to unfavorable deposition and/or layer growth deposition properties including increased deposition and/or growth rates at corners and edges. Such incomplete gap filling results in the formation of voids within the structures to be filled by the PVD- and CVD-materials. In addition to the formation of voids, the surface of the substrate is covered by a PVD and/or CVD layer that is almost as thick as the maximum depth of the deepest structure to be filled by the deposited gap filling material (see FIGS. 4 and 5). In some applications, however, it may be necessary to expose the surface of the substrate so that it is available for further processing. As a consequence, undesired overburden layers from PVD or CVD need to be removed, for example by chemical mechanical planarization (CMP) without harming the original substrate surface underneath. Although CMP is very well established in the process of manufacturing integrated circuits, CMP is a time consuming and costly process and can be seen as a potential economic drawback for mass production of leading-edge optical devices, particularly the mass production of diffractive gratings. It would therefore be desirable to have a solution for an advanced and cost-efficient manufacturing of optical gratings where gap filling does not require CMP (see FIG. 6).

The present invention addresses various disadvantages of the technologies for preparing optical gratings for leading edge optical devices as described above. The focus here is on improved optical properties, improved mechanical properties, improved coating properties and improved filling properties.

### OBJECT OF THE INVENTION

It is an object of the present invention to provide a formulation and a method for preparing optical metal oxide layers, wherein said metal oxide layers are particularly suitable for optical applications and may be used in optical devices such as, for example, in diffractive gratings for AR and/or VR devices. The obtained optical metal oxide layers show (a) favorable optical properties such as high refractive index (RI) of >1.7, preferably >2.0, at wavelengths of ≤520 nm, low absorption, and low degree of haze formation; (b) favorable mechanical properties such as low shrinkage, (c) favorable coating properties such as dense layer and flat surface structure; and (d) favorable filling properties such as homogeneous filling of topographical features on patterned substrates.

Moreover, it is an object of the present invention to provide a formulation and a method allowing an easy and cost-efficient preparation of optical metal oxide layers.

It is a further object of the present invention to enable preparation of optical metal oxide layers on the surface of patterned or non-patterned substrates. The metal oxide layers may form various structures such as, for example, layers covering a surface of a non-patterned substrate and/or fillings covering topographical features such as, for example, gaps on the surface of a patterned substrate, thereby providing highly refractive optical structures.

Hence, it is an object of the present invention to provide a formulation and a method for preparing optical metal oxide layers, wherein said method allows the preparation of advanced optical gap filling with low overburden, thus enabling an easy and cost-efficient mass production of complex optical devices.

It is a further object of the present invention to provide a method for preparing optical metal oxide layers which avoids typical problems occurring when layer deposition or gap filling is performed by PVD or CVD techniques such as, for example, incomplete or excessive gap filling due to unfavorable deposition and layer growth characteristics such as, for example, decreased or increased deposition or growth rates at corners and edges.

It is an object of the present invention that the metal complex and formulation are particularly suitable for the preparation of metal oxide optical layers having high refractive index and at the same time low absorption (optical loss) for optical devices such as, for example, for diffractive gratings in AR and/or VR devices

Finally, it is an object of the present invention to provide an optical device, preferably an AR and/or VR device, comprising an optical metal oxide layer, which is obtainable by the method according to the present invention or which is prepared by using the formulation according to the present invention, and thereby shows the above-mentioned beneficial effects.

### SUMMARY OF THE INVENTION

The present inventors surprisingly found that the above objects are achieved either individually or in any combination, by a formulation for preparing an optical metal oxide layer, wherein the formulation comprises:
(i) a complex comprising
a polyoxometalate moiety of formula (Ia), and

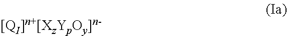

a nanoparticle of formula (Ib)

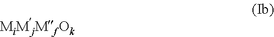

wherein
each Q independently represents a cation, preferably wherein the cation is selected from the group consisting of an ammonium cation, an alkali metal cation, an alkaline earth metal cation,
I is any number in the range from 1 to 20, preferably 1 to 10;
n is any number in the range from 1 to 20
n is a number representing the total positive charge n+ of I cations Q and the corresponding negative charge n− of the polyanion [X_{z}YₚO_{y}].
   X is a heteroatom, such as, e.g. B, Si, Ge, P, Al, As, or Sb;
   Y is a metal, preferably a transition metal;
   z is 0 to 20; p is 1 to 100; and y is 2 to 400;
   M, M′ and M,″ each independently, is a metal;
   i, j, and f each independently, is an integer or a fraction of 0 to 10; with the proviso that at least one of i, j, and f is not 0; and
   k is any number in the range of from 1 to 20, preferably from 1 to 5;
and
(ii) one or more formulation media.

In addition, a method for preparing an optical metal oxide layer is provided, comprising the following steps (a) to (c):
(a) providing a formulation wherein the formulation comprises:
(i) a complex comprising a polyoxometalate moiety of formula (Ia), and a nanoparticle of formula (Ib); and
(ii) one or more formulation media; and
(b) applying the formulation on the surface of a substrate; and
(c) converting the formulation on the surface of the substrate to an optical metal oxide layer.

Moreover, an optical device is provided comprising an optical metal oxide layer, which is obtainable or obtained by the method according to the above-mentioned preparation method.

The present invention further relates to the use of the above-mentioned formulation for forming an optical metal oxide layer.

Preferred embodiments of the present invention are described hereinafter and in the dependent claims.

### BRIEF DESCRIPTION OF THE FIGURES

FIG. 1: Schematic cross-sectional view of a SR grating with a Material 01 and a Material 02, wherein the refractive index IR 01 of Material 01 is incrementally different to the refractive index IR 02 of Material 02.

FIG. 2: Schematic cross-sectional view of a SR grating enabling light diffraction (transmissive case) including propagation of diffracted light within waveguide (e.g. lens) by total internal reflection.

FIG. 3: Schematic cross-sectional view of a SR grating providing gaps (trenches) to be filled with a high refractive index material (Material 02), wherein the refractive index of Material 02 is incrementally different form the refractive index of Material 01 flanking the gaps (trenches).

FIG. 4: Schematic representation of PVD- or CVD-mediated gap filling process and removal of undesired overburden.

FIG. 5: Schematic representation of PVD- or CVD-mediated gap filling process creating and leaving voids within gaps and deposited layers.

FIG. 6: Schematic representation of gap filling process using formulations containing inventive metal complex or formulations thereof being converted to metal oxides.

FIGS. 7A and 7B: show the comparison of UV-Vis spectra of diluted samples of the supernatant solutions (A) and of the dissolved products (B) obtained using standard and solvent methods.

FIG. 8: show an FT-IR spectrum of dried samples of products obtained using the purification method 1 and 2.

FIG. 9: shows reaction mixtures with products precipitated with time after adding 10% (v/v) solvent.

FIG. 10: shows pure solutions of K₈Nb₆O₁₉ in mixed solvent systems of the added solvent, isopropanol, and water.

FIG. 11: shows the refractive index dependence on PW—TiO₂ weight fraction for the PW—TiO₂/PW—SnO₂ mixture.

FIG. 12: shows the refractive index of the mixture PW—TiO₂ and PW-A as a function of PW—TiO₂ weight percent content measure on a thin film deposited on a Si substrate and cured at 300° C.

FIG. 13: shows the refractive index of the PW—TiO₂ and PW—SnO₂ mixture (0.94 PW—TiO₂ weight fraction) as a function of the weight fraction of the varied amounts of PW-A added.

FIG. 14: shows the surface feature filling of the spin coated of formulation of 5 wt % PW—SnO₂ after soft-bake at 100° C. for 1 min and hard-bake at 300° C. for 10 min.

FIG. 15A: shows the surface feature filling of the drop casted 10 wt % PW—SnO₂ with 0.5 wt % BYK348 in H₂O after soft-bake at 100° C. for 1 min and bake at 300° C. for 10 min.

FIG. 15B: shows the surface feature filling of the spin coated 10 wt % PW—SnO₂ with 0.5 wt % BYK348 in H₂O after soft-bake at 100° C. for 1 min and bake at 200° C. for 10 min.

FIG. 16: shows the surface feature filling of the spin coated mixture of Example T3 (PW—SnO₂/PW @ 1.8/1 weight ratio) after soft-bake at 100° C. for 1 min and hard-bake at 300° C. for 10 min.

FIGS. 17A and 17B show the surface feature filling of the spin coated mixture NbO—Sn_{0.25}Ti_{0.75}O₂+NbO-A after prebake at 100° C. for 1 min. Two trench widths are shown: 114 nm (FIG. 17A) and 87.5 nm (FIG. 17B).

FIG. 17C shows the surface feature filling of the spin coated mixture NbO—Sn_{0.25}Ti_{0.75}O₂+NbO-A after hard-baking at 300° C. for 10 min followed by soft-bake of 100° C. for 1 minute. 84 nm trench width is shown.

FIGS. 18A and 18B show the surface feature filling of the spin coated mixture NbO—SnO₂\TiO₂ 25/75%+NbO after soft-bake at 100° C. for 1 min and hard-bake at 300° C. for 10 min. Trench width is 114 nm (FIG. 18A) and 131 nm (FIG. 18B).

FIG. 18C: shows the surface feature filling of the spin coated mixture NbO—SnO₂\TiO₂ 25/75%+NbO-A after two layers without any soft-bake in between and a final soft-bake at 100° C. for 1 min after a second layer and a hard-bake at 300° C. for 10 min after soft-bake.

FIG. 19A: shows an exemplary scheme of a POMs complexed to a nanoparticle.

FIG. 19B: shows the packaging of POMs on the surface of a NP where the radius of the NP is much larger than the radius of the POM to illustrate the calculation of the core radius.

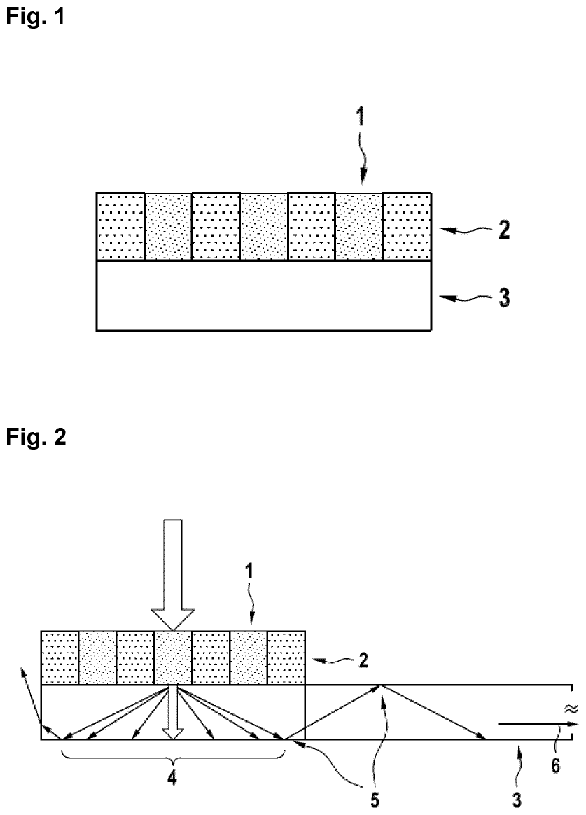

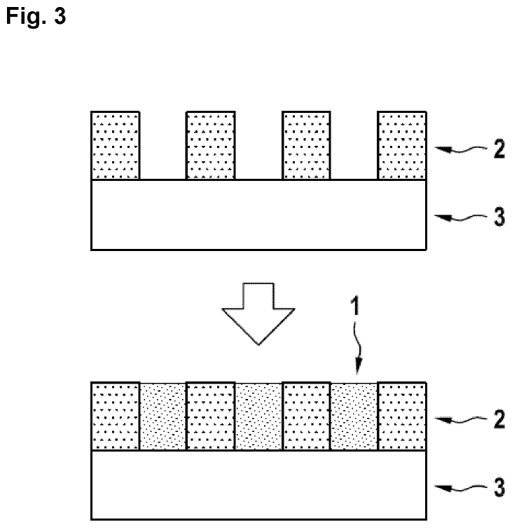

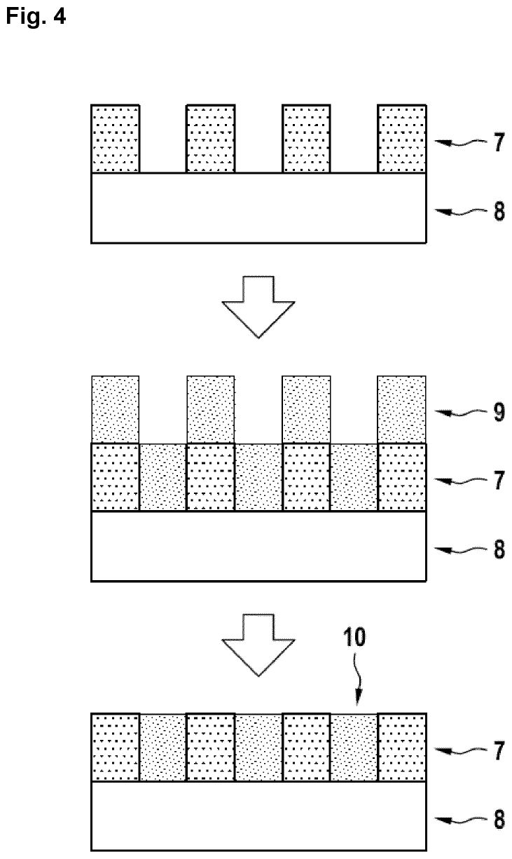

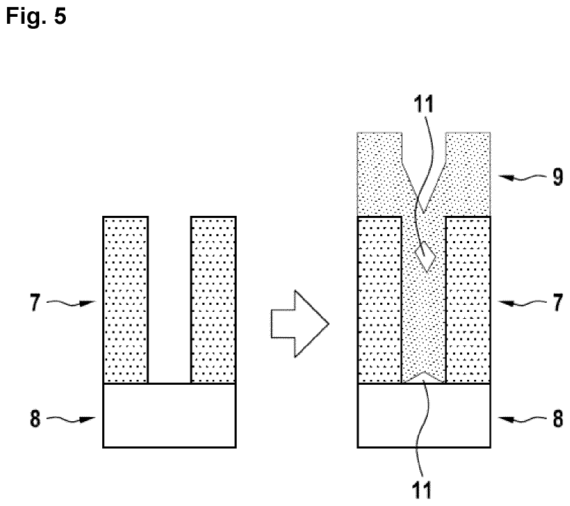

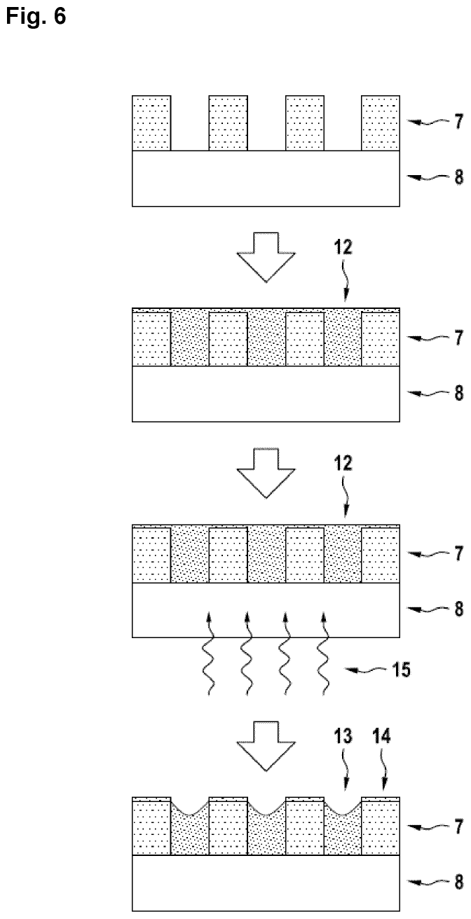

### LIST OF REFERENCE SIGNS

1 Material 02 with RI 02
2 Material 01 with RI 01
3 Substrate (e.g. glass)
4 Diffraction of incident light represented by broad arrow
5 Total internal reflection of light (TIR)
6 Waveguide
7 Structured layer stack with gaps (trenches)
8 Substrate (e.g. glass or silicon)
9 Overburden of material (e.g. high refractive index material or high etch resistant material)
10 Material (e.g. high refractive index material or high etch resistant material) providing gap fill
11 Voids
12 Formulation (e.g. ink) of high refractive index material (e.g. metal oxide precursor)
13 High refractive index material (e.g. metal oxide) providing gap fill with optional concave geometry
14 Overburden layer (optional)
15 Energy
100 Nanoparticle (NP)
102 polyoxometalate (POM)
104 projection of a POM on the NP spherical surface
106 radius R

### DETAILED DESCRIPTION

### Definitions

In the context of the present invention, the term “formulation medium” or the plural term “formulation media” as used herein, denote one or more compounds serving as a solvent, suspending agent, carrier and/or matrix for the complex and any other component included in the formulation. Formulation media are generally inert compounds that do not react with said complex and said other components. Formulation media may be liquid compounds, solid compounds or mixtures thereof. A preferred formulation medium is water.

When numerical ranges herein are indicated using “to,” they include both end points. For example, 1 to 10 means 1 or more and 10 or less.

The term “surfactant” as used herein, refers to an additive that reduces the surface tension of a given formulation.

The term “wetting and dispersion agent” as used herein, refers to an additive that increases the spreading and penetrating properties of a given formulation. In this way, the tendency of the molecules to adhere to each other is reduced.

The term “adhesion promoter” as used herein, refers to an additive that increases the adhesion of a given formulation.

The term “coordinating surfactant” as used herein, refers to an additive that coordinates metal ions and acts as a surfactant.

The term “viscosity enhancer” as used herein, refers to an additive that increases the viscosity of a given formulation.

The term “optical device” as used herein, relates to a device containing one or more optical components for forming a light beam including, but not limited to, gratings, lenses, prisms, mirrors, optical windows, filters, polarizing optics, UV and IR optics, and optical coatings. Preferred optical devices in the context of the present invention are augmented reality (AR) glasses and/or virtual reality (VR) glasses.

The term “metal” as used herein includes alkali metals, alkaline-earth metals, transition metals, rare-earth element, post-transition metals, actinoid elements, metalloids, and lanthanoid elements.

The term “post-transition metal” as used herein, relates to Al, Ga, In, Sn, Ti, Pb, Bi, Nh, Fl, Mc, and Lv.

The term “metalloid” as used herein, relates to B, Si, Ge, As, Sb, Te, and Po.

A cation “Q” as used herein, maybe a proton, an ammonium cation, an alkali metal cation, and an alkaline earth metal cation.

The term “nanoparticle” or “NP” as used herein is generic for individual units having a structure in which at least one dimension is on a nanometer scale (i.e. from 1 nm up to 1 micro m). The term “nanoparticle” includes quantum dots, spherical and pseudo-spherical particles, faceted particles, nanorods, nanowires, tetrapods, anisotropic particles, nano platelets, and other suitable particles. Further, the term “nanoparticle” includes single crystal nanoparticles (i.e. nanocrystals), polycrystalline nanoparticles, and amorphous nanoparticles. The nanoparticle, as referred to herein, is represented by formula (Ib)

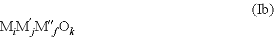

M, M′ and M,″ each independently, is a metal;
i, j, and f each independently, is an integer or a fraction of 0 to 10; with the proviso that at least one of i, j, and f is not 0; and
k is any number in the range of from 1 to 20, preferably from 1 to 5.

The polyoxometalate or “POM,” as referred to herein, is represented by formula (Ia),

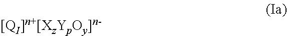

wherein
each Q independently represents a cation, preferably wherein the cation is selected from the group consisting of an ammonium cation, an alkali metal cation, an alkaline earth metal cation,
I is any number in the range from 1 to 20, preferably 1 to 10;
n is a number representing the total positive charge n+ of I cations Q and the corresponding negative charge n− of the polyanion [X_{z}YₚO_{y}].
X is a heteroatom, such as, e.g. B, Si, Ge, P, Al, As, or Sb;
Y is a metal, preferably a transition metal; and
z is 0 to 20; p is 1 to 100; and y is 2 to 400.

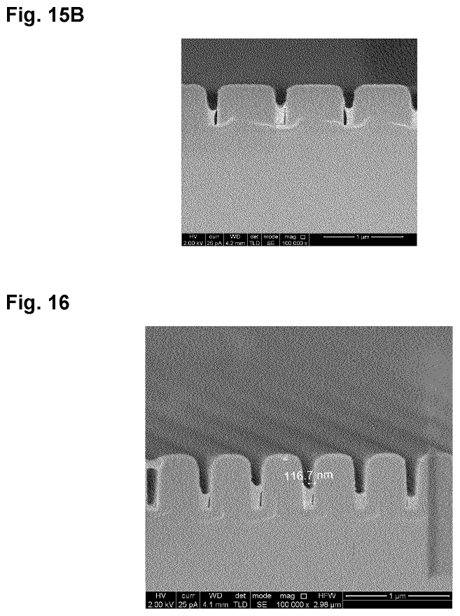

The complexes referred to herein relate to a metal oxide nanoparticle that is complexed to POMs which act as ligands. FIG. 15A shows a schematic drawing of such a complex comprising polyoxometalate moieties according to formula Ia and a nanoparticle according to formula Ib. In some instances, a single M, M,′ and M″ of the nanoparticle may be considered as part of the polyoxometalate, e.g. when the polyoxometalate is a lacunary polyoxometalate, the polyoxometalate moiety of Na₇[PW₁₁O₃₉] complexed to TiO₂ may be viewed as [PW₁₁O₃₉Ti]—O⁻. When referring herein to POMs complexed to NPs it should be understood that the aforementioned depiction is also covered.

The use of POMs as protecting ligands complexed to NPs, resulting in POM-NP—isolable and water-soluble nanostructures, is known from literature, e.g.:
(1) Y. Wang, I. Weinstock, Chem. Soc. Rev., 2012, 41, 7479-7496.
(2) M. Raula, G. Gan Or, M. Saganovich, O. Zeiri, Y. Wang, M Chierotti, R. Gobetto, I. Weinstock, Angew. Chem. Int. Ed. 2015, 54, 12416-12421.
(3) Anna Llordes, Aaron T. Hammack, Raffaella Buonsanti, Ravisubhash Tangirala, Shaul Aloni, Brett A. Helmsa and Delia J. Milliron, J. Mater. Chem., 2011, 21, 11631-11638.

### PREFERRED EMBODIMENTS

### Formulation for Preparing an Optical Metal Oxide Layer

In a first aspect, there is provided a formulation for preparing an optical metal oxide layer, wherein the formulation comprises:
(i) a complex comprising a polyoxometalate moiety of formula (Ia), and

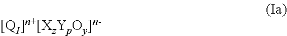

a nanoparticle represented by formula (Ib)

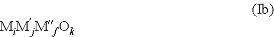

wherein
each Q independently represents a cation, preferably wherein the cation is selected from the group consisting of an ammonium cation, an alkali metal cation, an alkaline earth metal cation,
I is any number in the range from 1 to 20, preferably 1 to 10;
n is a number representing the total positive charge n+ of I cations Q and the corresponding negative charge n− of the polyanion [X_{z}YₚO_{y}];
X is a heteroatom, such as, e.g. B, Si, Ge, P, Al, As, or Sb;
Y is a metal, preferably a transition metal;
z is 0 to 20; p is 1 to 100; and y is 2 to 400;
M, M′ and M,″ each independently, is a metal;
i, j, and f each independently, is an integer or a fraction of 0 to 10; with the proviso that at least one of i, j, and f is not 0; and
k is any number in the range of from 1 to 20, preferably from 1 to 5;
and
(ii) one or more formulation media.

Preferably, (Na₇[α-PW₁₁O₃₉]) complexed to TiO₂ nanoparticles, Na₃[PMo₁₂O₄₀] complexed to TiO₂, K₆[P₂W₁₈O₆₂] complexed to TiO₂, K₆[P₂Mo₁₈O₆₂] complexed to TiO₂, or Q_{I}[SiW₁₁O₃₉] complexed to TiO₂, are excluded from the formulation according to the first aspect.

In some embodiments, the complex is represented by formula (I)

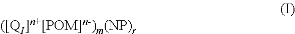

wherein
I is any number in the range of from of 1 to 40;
POM is a polyoxometalate ligand represented by the formula (Ia);
n is a number representing the total positive charge n⁺ of Q and the corresponding negative charge n of the polyoxometalate ligand and wherein n can be any number in the range from 2 to 20;
NP is a nanoparticle represented by formula (Ib);
m represents the number of polyoxometalate ligands per nanoparticle, and is any number in the range of from 1 to 5000; and
r is any number in the range from 1 to 20000 and represents an empirical metal-oxide unit in the nanoparticle.

In formula (I) or (Ia), each Q independently represents a cation selected from the group consisting of a proton, an ammonium cation, an alkali metal cation, an alkaline earth metal cation. In preferred embodiments, each Q independently represents an alkali metal, such as, e.g. Na or K.

Polyoxometalates (POMs) can be considered as clusters, generally anionic, formed from monomeric oxo species of transition metals with one or more bridging oxygen atoms. A basic POM framework is designated herein “YₚO_{y}”, wherein p and y are the total amount of metal and oxygen ions, respectively. Such POMs are also referred to as isopolyanions or iso-polyoxometalates. Apart from Y and O, other elements, herein labelled as X, can be part of the POM framework. As a general rule, the X elements are 4-fold- or 6-fold-coordinated and lie in the center of the YₚO_{y} shell or cage (X may also be referred to as “core heteroatom”). If X is present the POM may be referred to as heteropolyanion or heteropolyoxometalate, which may be represented by [X_{z}YₚO_{y}]ⁿ⁻, wherein z>0. In some embodiments, the POM is a lacunary POM, such as, e.g. [PW₁₁O₃₉]⁷⁻.

“X” may be referred to as primary or central heteroatom. In general, any element may participate as X in a POM cluster since there are no strict physical requirements for this position. Exemplary “X” include, but are not limited to, B, Si, Ge, P, Al, As, Sb, etc. “Y” may be referred to as secondary, peripheral or addenda atoms. Y may be one or more different metals. Usually, only certain metals are typically found in such compounds. In anions in which more than one type of Y addenda-type is present in the framework, the molecule may be referred to as a mixed-addenda cluster. Exemplary “Y” include, but are not limited to, W, Nb, V, Ta, Ti, Zr, Hf, Mo, Zn, In, or Sn.

In some embodiments, the POM is a heteropolyoxometalate, preferably [Q₇][PW₁₁O₃₉], such as e.g. [Na₇][PW₁₁O₃₉]. In some embodiments the POM is an isopolyoxometalate, preferably [Q₈][Nb₆O₁₉], such as e.g. [K₈][Nb₆O₁₉].

In some embodiments, z is 0. In a preferred embodiment, X is P, Si, or Al and/or Y is W, Nb, V, Ta, Ti, Zr, Hf, Mo, Zn, In, or Sn. In a particularly preferred embodiment, the POM is a heteropolyoxotungstate or an isopolyoxoniobate. A particularly preferred heteropolyoxotungstate is Q₇[PW₁₁O₃₉], wherein each Q individually is Na or K, preferably wherein Q is Na. A particularly preferred isopolyoxoniobate is Q₈[Nb₆O₁₉], wherein each Q individually is Na or K, preferably wherein Q is K.

Each nanoparticle may comprise “r” units of formula Ib. The number of POMs complexed to a NP “m” may increase according to the increase in r as a function of crystal morphology. “m” may be any number in the range of from 1 to 5000 and r may be any number in the range from 1 to 20000. The complexes may comprise POMs that are covalently complexes to NPs.

In some embodiments, the nanoparticle represented by formula Ib is crystalline and referred to herein as a nanocrystal.

In some embodiments, M, M,′ and M″, each independently, is Ba, Sr, Ti, Zr, Nb, Hf, Ta, Zn, Al, In, Sn, or Ce, optionally in a high oxidation state. In a preferred embodiment, M, M,′ and M″, each independently, is Ba(II), Sr(II), Ti(III), Ti(IV), Zr(IV), Nb(V), Nb(III), Hf(IV), Ta(V), Zn(II), Al(III), In(III), Sn(II), Sn(IV) or Ce(IV).

In a particularly preferred embodiment, M′ is Ti, optionally Ti(IV) and/or M is Sn, optionally Sn(IV).

In a further preferred embodiment, f is 0. In a more preferred embodiment, f is zero, and either k or j is also 0 or, k is <1 and j is 1-k. In some embodiments, i and j, each individually, is a fraction of 1. In some embodiments, the nanoparticle represented by formula 1b is a mixed metal oxide such as, e.g. SnᵢT₁₋ᵢO₂, wherein i is any fraction between 0 and 1, such as, e.g. 0.05, 0.12, 0.15, 0.20, 0.25, 0.35, 0.75. The term “fraction of 1” means any fraction between 0 and 1, such as, e.g. 0.01, 0.008, 0.12, 017, 0.23, 0.28, 0.30, 0.35, 0.36, 0.41, 0.47, 0.50, 0.62, 0.77, 0.81, 0.98, or 0.99. Non-limiting examples of mixed metal oxides are Sn_{0.13}Ti_{0.87}O₂, Sn_{0.54}Ti_{0.46}O₂, Sn_{0.25} Ti_{0.75}O₂, and Sn_{0.5}Ti_{0.5}O₂. A mixed metal oxide nanoparticle may also be referred to herein as doped metal oxide nanoparticle. For examples, Sn_{0.13}Ti_{0.87}O₂ may be referred to as titanium oxide nanoparticle doped with Sn. Mixed metal oxide nanoparticles such as e.g. Sn_{0.13} Ti_{0.87}O₂ may allow for tuning the refractive index by adjusting the ratio between M and M′, e.g. Sn and Ti, to find an optimal ratio.

In some embodiment, the nanoparticle is SnO₂, CeO₂, ZrO₂, TiO₂, NbO₂, HfO₂, or Ta₂O₅.

In a preferred embodiment, the complex according to formula (I) is a heteropolyoxotungstate, such as e.g. ([Na₇][PW₁₁O₃₉]), complexed to TiO₂ NPs or SnO₂ NPs or a mixed metal oxide NPs such as SnₓT₁₋ₓO₂ NPs. In a further preferred embodiment, the complex according to formula (I) is a polyoxoniobate, such as e.g. ([K₈][Nb₆O₁₉]), complexed to TiO₂ NPs or SnO₂ NPs or a mixed metal oxide NP such as SnₓT₁₋ₓO₂ NPs.

In a preferred embodiment, the complex according to formula (I) is ([Na₇][PW₁₁O₃₉]) complexed to SnO₂ nanoparticles, ([K₈][Nb₆O₁₉]) complexed to SnO₂ nanoparticles, ([K₈][Nb₆O₁₉]) complexed to Sn_{0.5}Ti₅O₂ nanoparticles, ([K₈][Nb₆O₁₉]) complexed to Sn_{0.25}Ti_{0.75}O₂ nanoparticles, ([K₈][Nb₆O₁₉]) complexed to Sn_{0.13}Ti_{0.87}O₂ nanoparticles, (K₈[Nb₆O₁₉]) complexed to TiO₂ nanoparticles, (K₈[Nb₆O₁₉]) complexed to Sn_{0.54}Ti_{0.46}O₂, or Na₇[PW₁₁O₃₉] complexed to TiO₂ nanoparticles.

In a preferred embodiment, the complex according to formula (I) is ([Na₇][PW₁₁O₃₉])ₘ(SnO₂)ᵣ, ([K₈][Nb₆O₁₉])ₘ(SnO₂)ᵣ, (K₈[Nb₆O₁₉])ₘ(Sn_{0.5}Ti_{0.5}O₂)ᵣ, ([K₈][Nb₆O₁₉])ₘ(Sn_{0.25}Ti_{0.75}O₂)ᵣ, ([K₈][Nb₆O₁₉])ₘ(Sn_{0.13} Ti_{0.87}O₂)ᵣ, ([K₈][Nb₆O₁₉])ₘ(Sn_{0.54}Ti_{0.46}O₂)ᵣ, ([K₈][Nb₆O₁₉])ₘ(TiO₂)ᵣ, or ([Na₇][PW₁₁O₃₉]ₘ(TiO₂)ᵣ, preferably wherein m is any number in the range from 1 to 5000; and r is any number in the range from 1 to 20000, more preferably wherein m is any number in the range from 1 to 1000, and r is and number in the range from 1 to 6000.

In some embodiments, the formulation further comprises (iii) one or more additive. Each additive may individually be selected from the group consisting of a further complex comprising a polyoxometalate represented by formula (Ia) and a nanoparticle represented by formula (Ib), a polyoxometalate represented by formula (Ia), a wetting agent, a dispersion agent, an adhesion promoter, a polymer matrix, and a surfactant.

The presence of one or more additive in the formulation according to the invention may improve the properties of the optical metal oxide layer obtained or obtainable by said formulation such as e.g. material hardness, shrinkage, refractive index, transparency, absorbance, and haze suppression.

In some embodiments, the formulation further comprises a polyoxometalate represented by formula (I) as additive. (Q_{I})[PW₁₂O₄₀] or (Q_{I})[Nb₆O₁₉] are preferred additives. In some embodiment, the polyoxometalate comprises the same elements as the polyoxometalate moiety of the complex of formula (I).

In particularly preferred embodiments, each Q independently represents an alkali metal cation, preferably K or Na.

In further preferred embodiments, the formulation comprises (i) a first complex represented by formula (I), (ii) one or more formulation media; and (iii) a second complex represented by formula (I), wherein the first and the second complex of formula (I) are not the same.

In further preferred embodiments, the formulation comprises (i) a first complex represented by formula (I), (ii) one or more formulation media; and (iii) a second complex represented by formula (I), wherein the first and the second complex of formula (I) are different.

In preferred embodiments, the formulation comprises
(i) a complex comprising a ([Na₇][PW₁₁O₃₉]) complexed to SnO₂ nanoparticles,
(ii) one or more formulation media,
(iii) a further complex comprising a ([Na₇][PW₁₁O₃₉]) complexed to TiO₂, and optionally Na₃PW₁₂O₄₀*H₂O.

In preferred embodiments, the formulation comprises
(i) a complex comprising a heterooxopolytungstate, such as, e.g. ([Q₇][PW₁₁O₃₉]) complexed to a nanoparticle according to formula (Ib) or an isopolyoxoniobate, such as, e.g. Q₈[Nb₆O₁₉] complexed to a nanoparticle according to formula (Ib),
(ii) one or more formulation media,
(iii) a polyoxometalate, preferably ([Q_{I}][PW₁₂O₄₀]) or ([Q_{I}][Nb₆O₁₉]).

Preferred surfactants are surface active substances, which preferably include surface active metal oxides and/or surface-active organic compounds. Surface-active organic compounds may include nonionic surfactants, anionic surfactants, and ampholytic surfactants and they may be coordinating or non-coordinating.

Examples of nonionic surfactants include, polyoxyethylene alkyl ethers, such as polyoxyethylene lauryl ether, polyoxyethylene oleyl ether and 30 polyoxyethylene cetyl ether; polyoxyethylene fatty acid diester; polyoxyethylene fatty acid monoester; polyoxyethylene polyoxypropylene block polymer; acetylene alcohol; acetylene glycol; polyethoxylate of acetylene alcohol; acetylene glycol derivatives, such as polyethoxylate of acetylene glycol; fluorine-containing surfactants, for example, FLUORAD (trade name, manufactured by Sumitomo 3M Limited), MEGAFAC (trade name: manufactured by DIC Cooperation), SURFLON (trade name, 5 manufactured by Asahi Glass Co. Ltd); or organosiloxane surfactants, for example, KP341 (trade name, manufactured by Shin-Etsu Chemical Co., Ltd.), and the like. Examples of said acetylene glycol include 3-methyl-1-butyne-3-ol, 3-methyl-1-pentyn-3-ol, 3,6-dimethyl-4-octyne-3,6-diol, 2,4,7,9-tetramethyl-5-decyne-4,7-diol, 3,5-dimethyl-1-hexyne-3-ol, 2,5-dimethyl-3-10 hexyne-2,5-diol, 2,5-dimethyl-2,5-hexane-diol, and the like.

Examples of anionic surfactants include ammonium salt or organic amine salt of alkyl diphenyl ether disulfonic acid, ammonium salt or organic amine salt of alkyl diphenyl ether sulfonic acid, ammonium salt or organic amine salt of alkyl benzene sulfonic acid, ammonium salt or organic amine salt of polyoxyethylene alkyl ether sulfuric acid, ammonium salt or organic amine salt of alkyl sulfuric acid, and the like.

Examples of amphoteric surfactants include 2-alkyl-N-carboxymethyl-N-20 hydroxyethyl imidazolium betaine, lauric acid amide propyl hydroxysulfone betaine, and the like.

Preferred surface-active metal oxides are selected from the list consisting of aluminum oxide, calcium oxide, silica, and zinc oxide. Such surface-active metal oxides are preferably present as fine powders, more preferably as nanoparticles, which are optionally surface treated.

Preferred surface-active organic compounds are surface-active non-polymeric compounds or surface-active polymeric organic compounds, wherein said surface-active non-polymeric compounds are preferably selected from the list consisting of alcohols, alkoxylates, aromatics, ketones, esters, modified urea, silanes, siloxanes and soap-based foam stabilizers, which are optionally functionalized and/or modified; and wherein said surface-active polymeric compounds are preferably selected from the list consisting of hydroxy polyesters, maleinate resins, polyacrylates, polyethers, polyester, polysilanes, silicone resins, and waxes, which are optionally functionalized and/or modified; and which are optionally present as copolymers. In a preferred embodiment, the surface-active organic compound is used as a solution.

Preferred silanes are polyether-modified silanes, polyester-modified silanes, and polyether-polyester-modified silanes. Preferred siloxanes are polyether-modified siloxanes, polyester-modified siloxanes, and polyether-polyester-modified siloxanes.

Preferred polyacrylates are modified polyacrylates, preferably silicone-modified polyacrylates, polyether macromer-modified polyacrylates, and silicone and polyether macromer-modified polyacrylates, which are optionally present as copolymers.

Preferred polysilanes are polyether-modified polysilanes (e.g. PEG-Silane 6-9), polyester-modified polysilanes, and polyether-polyester-modified polysilanes.

Preferred silicone resins are polyether-modified polysiloxanes, preferably polyether-modified polydialkylsiloxanes, more preferably polyether-modified polymethylalkylsiloxanes, and most preferably polyether-modified polydimethylsiloxanes and polyether-modified, hydroxy-functional polydimethylsiloxanes; polyester-modified polysiloxanes, preferably polydialkylsiloxanes, more preferably polyester-modified polymethylalkylsiloxanes, and most preferably polyester-modified polydimethylsiloxanes and polyester-modified, hydroxy-functional polydimethylsiloxanes; polyether-polyester-modified polysiloxanes, preferably polyether-polyester-modified polydialkylsiloxanes, more preferably polyether-polyester-modified polymethylalkylsiloxanes, and most preferably polyether-polyester-modified polydimethylsiloxanes and polyether-polyester-modified, hydroxy-functional polydimethylsiloxanes; epoxy functional polysiloxanes, preferably epoxy functional polydialkylsiloxanes, more preferably epoxy functional polymethylalkylsiloxanes, and most preferably epoxy functional polydimethylsiloxanes; acryl functional polysiloxanes, preferably acryl functional polydialkylsiloxanes, more preferably acryl functional polymethylalkylsiloxanes, and most preferably acryl functional polydimethylsiloxanes; polyether-modified, acryl functional polysiloxanes, preferably polyether-modified, acryl-functional polydialkylsiloxanes, more preferably polyether-modified, acryl-functional polymethylalkylsiloxanes, and most preferably polyether-modified, acryl-functional polydimethylsiloxanes; polyester-modified, acryl-functional polysiloxanes, preferably polyester-modified, acryl-functional polydialkylsiloxanes, more preferably polyester-modified, acryl-functional polymethylalkylsiloxanes, and most preferably polyester-modified, acryl-functional polydimethylsiloxanes; and aralkyl-modified polysiloxanes, preferably aralkyl-modified polydialkylsiloxanes, more preferably aralkyl-modified polymethylalkylsiloxanes, and most preferably aralkyl-modified polydimethylsiloxanes; which are optionally present as copolymers.

Preferred surfactants are commercially available from BYK-Chemie GmbH, Wesel, Germany and offered as surface additives. Preferred surfactants are DISPERBYK (hereafter “BYK”) surfactants selected from BYK-300, BYK-301, BYK-302, BYK-306, BYK-307, BYK-310, BYK-313, BYK-315 N, BYK-320, BYK-322, BYK-323, BYK-325 N, BYK-326, BYK-327, BYK-329, BYK-330, BYK-331, BYK-332, BYK-333, BYK-342, BYK-345, BYK-346, BYK-347, BYK-348, BYK-349, BYK-350, BYK-352, BYK-354, BYK-355, BYK-356, BYK-358 N, BYK-359, BYK-360 P, BYK-361 N, BYK-364 P, BYK-366 P, BYK-368 P, BYK 370, BYK 375, BYK-377, BYK-378, BYK-381, BYK-390, BYK-392, BYK-394, BYK-399, BYK-2616, BYK-3400, BYK-3410, BYK-3420, BYK-3450, BYK-3451, BYK-3455, BYK-3456, BYK-3480, BYK-3481, BYK-3499, BYK-3550, BYK-3560, BYK-3565, BYK-3566, BYK-3750, BYK-3751, BYK-3752, BYK-3753, BYK-3754, BYK-3760, BYK-3761, BYK-3762, BYK-3763, BYK-3764, BYK-3770, BYK-3771, BYK-3780, BYK-3900 P, BYK 3902 P, BYK-3931 P, BYK 3932 P, BYK-3933 P, BYK-8020, BYK-8070, BYK-9890, BYK-DYNWET 800, BYK-S 706, BYK-S 732, BYK-S 740, BYK-S 750 N, BYK-S 760, BYK-S 780, BYK-S 782, BYK-SILCELAN 3700, BYK-SILCLEAN 3701, BYK-SILCLEAN 3710, BYK-SILCLEAN 3720, BYK-UV 3500, BYK-UV 3505, BYK-UV 3510, BYK-UV 3530, BYK-UV 3535, BYK-UV 3570, BYK-UV 3575, BYK-UV 3576; BYKETOL series such as BYKETOL-AQ, BYKETOL-OK, BYKETOL-PC, BYKETOL-SPECIAL, BYKETOL-WA, NANOBYK series such as NANOBYK-3603, NANOBYK-3605, NANOBYK-3620, NANOBYK-3650, NANOBYK-3652, and NANOBYK-3822.

The wetting and dispersion agents used in the present invention are additives, which provide both wetting and/or stabilizing effects for formulations containing fine solid particles. They result in a fine and homogenous distribution of solid particles in a formulation media, preferably liquid formulation media, and ensure long-term stability of such systems. The formulation media may comprise water and the entire range of organic solvents of varying polarity. Moreover, they result in an improved wetting of solids and prevent particles from flocculating by various mechanisms (e.g. by electrostatic effects, steric effects, etc.).

Preferably, the wetting and dispersion agents are organic polymers or organic copolymers having polar functional groups selected from amino groups; amide groups; carbamate groups; carbonate groups; acidic groups, preferably boric acid groups, boronic acid groups, carboxylic acid groups, sulfuric acid groups, sulfonic acid groups, phosphoric acid groups, phosphonic acid groups, and phosphinic acid groups; ester groups, preferably boric ester groups, boronic ester groups, carboxylic ester groups, sulfuric ester groups, sulfonic ester groups, phosphoric ester groups, phosphonic ester groups, and phosphinic ester groups; ether groups; hydroxy groups; keto groups; and urea groups; wherein the organic polymers or copolymers may be present as a conjugate, derivative and/or salt, preferably as a salt. Preferred salts are ammonium salts, alkyl ammonium salts, alkylol ammonium salts, or alkaline metal salts such as preferably Li, Na, K and Rb salts. The polar functional groups may be also referred to as pigment-affinic groups or as filler-affinic groups. In a preferred embodiment, the wetting and dispersion agent is used as a solution.

More preferably, the wetting and dispersion agents are organic polymers or organic copolymers selected from acrylates; amides; carboxylic acids; and esters; wherein the organic polymers or copolymers may be present as a conjugate, derivative and/or salt, preferably as a salt; and wherein they may be further functionalized with one or more polar functional group as described above. Preferred salts are ammonium salts, alkyl ammonium salts, alkylol ammonium salts, or alkaline metal salts such as preferably Li, Na, K and Rb salts. In a preferred embodiment, the wetting and dispersion agent is used as a solution.

The wetting and dispersion agents may be present as a mixture, preferably as a mixture with a polysiloxane copolymer.

Preferred wetting and dispersing agents are commercially available from BYK-Chemie GmbH, Wesel, Germany. Preferred wetting and dispersing agents are ANTI-TERRA-202, ANTI-TERRA-203, ANTI-TERRA-204, ANTI-TERRA-205, ANTI-TERRA-210, ANTI-TERRA-250, ANTI-TERRA-U, ANTI-TERRA-U 80, ANTI-TERRA-U 100, BYK-151, BYK-153, BYK-154, BYK-155/35, BYK-156, BYK-220 S, BYK-1160, BYK-1162, BYK-1165, BYK-9076, BYK-9077, BYK-GO 8702, BYK-GO 8720, BYK-P 104, BYK-P 104 S, BYK-P 105, BYK-SYNERGIST 2100, BYK-SYNERGIST 2105, BYK-W 900, BYK-W 903, BYK-W 907, BYK-W 908, BYK-W 909, BYK-W 940, BYK-W 961, BYK-W 966, BYK-W 969, BYK-W 972, BYK-W 974, BYK-W 980, BYK-W 985, BYK-W 995, BYK-W 996, BYK-W 9010, BYK-W 9011, BYK-W 9012, BYKJET-9131, BYKJET-9132, BYKJET-9133, BYKJET-9142, BYKJET-9150, BYKJET-9151, BYKJET-9152, BYKJET-9170, BYKJET-9171, BYKUMEN, DISPERBYK, DISPERBYK-101 N, DISPERBYK-102, DISPERBYK-103, DISPERBYK-106, DISPERBYK-107, DISPERBYK-108, DISPERBYK-109, DISPERBYK-110, DISPERBYK-111, DISPERBYK-115, DISPERBYK-118, DISPERBYK-130, DISPERBYK-140, DISPERBYK-142, DISPERBYK-145, DISPERBYK-161, DISPERBYK-162, DISPERBYK-162 TF, DISPERBYK-163, DISPERBYK-163 TF, DISPERBYK-164, DISPERBYK-165, DISPERBYK-166, DISPERBYK-167, DISPERBYK-167 TF, DISPERBYK-168, DISPERBYK-168 TF, DISPERBYK-169, DISPERBYK-170, DISPERBYK-171, DISPERBYK-174, DISPERBYK-180, DISPERBYK-181, DISPERBYK-182, DISPERBYK-184, DISPERBYK-185, DISPERBYK-187, DISPERBYK-190, DISPERBYK-190 BF, DISPERBYK-191, DISPERBYK-192, DISPERBYK-193, DISPERBYK-194 N, DISPERBYK-199, DISPERBYK-199 BF, DISPERBYK-2000, DISPERBYK-2001, DISPERBYK-2008, DISPERBYK-2009, DISPERBYK-2010, DISPERBYK-2012, DISPERBYK-2013, DISPERBYK-2014, DISPERBYK-2015, DISPERBYK-2015 BF, DISPERBYK-2018, DISPERBYK-2019, DISPERBYK-2022, DISPERBYK-2023, DISPERBYK-2025, DISPERBYK-2026, DISPERBYK-2030, DISPERBYK-2050, DISPERBYK-2055, DISPERBYK-2059, DISPERBYK-2060, DISPERBYK-2061, DISPERBYK-2062, DISPERBYK-2070, DISPERBYK-2080, DISPERBYK-2081, DISPERBYK-2096, DISPERBYK-2117, DISPERBYK-2118, DISPERBYK-2150, DISPERBYK-2151, DISPERBYK-2152, DISPERBYK-2155, DISPERBYK-2155 TF, DISPERBYK-2157, DISPERBYK-2158, DISPERBYK-2159, DISPERBYK-2163, DISPERBYK-2163 TF, DISPERBYK-2164, DISPERBYK-2190, DISPERBYK-2200, DISPERBYK-2205, DISPERBYK-2290, DISPERBYK-2291, DISPERPLAST-1142, DISPERPLAST-1148, DISPERPLAST-1150, DISPERPLAST-1180, DISPERPLAST-I, and DISPERPLAST-P.

Preferred adhesion promoters are block copolymers, preferably high molecular weight block copolymers; copolymers with functional groups, preferably hydroxy-functional copolymers with acidic groups, styrene-ethylene/butylene-styrene block copolymer (SEBS) functionalized with maleic acid anhydride, carboxylated SEBS functionalized with maleic anhydride, SEBS functionalized with glycidyl methacrylate, polyolefin block copolymer functionalized with maleic acid anhydride, and ethylene octene copolymer functionalized with maleic anhydride; and polymers with functional groups, preferably polymers with acidic groups, and polypropylene functionalized with maleic anhydride. In a preferred embodiment, the adhesion promoter is used as a solution.

Preferred adhesion promoters are commercially available from BYK-Chemie GmbH, Wesel, Germany. Preferred adhesion promoters are BYK-4500, BYK-4509, BYK-4510, BYK-4511, BYK-4512, BYK-4513, SCONA TPKD 8102 PCC, SCONA TSIN 4013 GC, SCONA TSPOE 1002 GBLL, SCONA TPPP 2112 FA, SCONA TPPP 2112 GA, SCONA TPPP 8112 GA, SCONA TSKD 9103, SCONA TPPP 8112 FA, SCONA TPKD 8304 PCC, and SCONA TSPP 10213 GB.

Preferred polymer matrices are polymethyl methacrylate, polyvinylpyrrolidone, polycarbonate, polystyrene, polymethylpentene, and silicone.

In some embodiments, the one or more formulation media are solution media and/or dispersion media. In preferred embodiments, the one or more formulation media is selected from water, amides, aromatic hydrocarbons, non-aromatic hydrocarbons, alcohols, carboxylic acids, esters, ethers, ketones, diketones, lactones, and mixtures thereof. In particularly preferred embodiments, one formulation medium is water. In further particularly preferred embodiments, the formulation medium is water.

It is preferred that the total content of the complex in the formulation is in the range of 0.1 to 25 wt %, preferably 0.5 to 20 wt %, more preferably 1 to 12 wt % based on the total mass of the formulation. The total content of the complex in the formulation may include one, two, three, four, five, or more different complexes. For example, the total content of the complex in the formulation may include a first complex of formula (I) and a second complex of formula (I), wherein the first complex of formula (I) and the second complex of formula (I) are not the same complex. The first complex of formula (I) and the second complex of formula (I) may be present in equal amounts. The mass ratio (w/w) between the first complex of formula (I) and the second complex of formula (I) may be in the range from 1:100 to 100:1, preferably from 1:10 to 10:1, and more preferably from 1:5 to 5:1.

In a preferred embodiment of the present invention, the formulation is an ink formulation being suitable for inkjet printing. Typical requirements for ink formulations are surface tensions in the range from 20 mN/m to 30 mN/m and viscosities in the range from 5 mPa·s to 10 mPa·s.

### Method of Preparation

According to a second aspect, there is provided a method for producing a formulation comprising a complex as described herein above, wherein the method comprises the following steps:
a) providing an aqueous solution comprising a complex as described herein above, wherein the complex is present in the range from 0.1 to 10 wt % based on the total amount of the aqueous solution;
b) adding a saturated solution of Q_{I}Xₚ, optionally to a final salt concentration of about 1M, to reversibly precipitate the complex, wherein
X is a halide such as e.g. F, Cl, Br, I, preferably CI;
Q is an ammonium cation, an alkali metal cation, or an alkaline earth metal cation, preferably Q is Na or K;
I is any number in the range from 1 to 20, preferably 1 to 10;
p is any number in the range from 1 to 20, preferably from 1 to 10;
c) centrifuging to obtain the precipitated complex as a pellet;
d) adding water to said pellet
optionally e) repeating step b), step c) and step d) one or more times to obtain a slurry;
f) filtering;
g) repeating step b), step c) and step d) to obtain a slurry;
h) subjecting the slurry obtained in step g) to dialysis to obtain a concentrated solution of the complex, wherein the complex is present in the range from 0.1 to 5 wt %, preferably 0.5 to 2.5 wt %, based on the total mass of the formulation.

In some embodiments, the method further comprises a step h) of further concentrating the solution obtained or obtainable in step g) using a gentle stream of compressed air.

In some embodiment, the solution obtained or obtainable by step g) is centrifuged to form a bottom layer and a top layer, wherein the bottom layer is redissolved using one or more formulation media to obtain a final concentration of the complex in the range from 2.5 to 25 wt %, preferably from 5 to 20 wt %, based on the total mass of the formulation.

According to an alternative second aspect, there is provided a method for producing a formulation comprising a complex as described herein above, wherein the method comprises the following steps:
a) providing an aqueous solution comprising a complex as described herein above, wherein the complex is present in the range from 0.1 to 10 wt % based on the total amount of the aqueous solution;
b) adding an antisolvent, such as, e.g. DMSO, DMF, acetone, isopropanol, methanol, preferably methanol;
c) centrifuging (and\or filtering) to obtain the precipitated complex as a pellet;
d) adding water to said pellet;
e) optionally repeating step b) and step c) and step d) one or more times to obtain a purer slurry;

Conveniently the use of an anti-solvent, in particular methanol, allows for a more efficient purification by reducing the number of steps needed. In addition, methanol is readily removeable, e.g. under reduced pressure. Preferably, dialysis steps can be eliminated. And it is believed that the selected good antisolvent, e.g. DMSO, DMF, acetone, isopropanol, methanol, preferably methanol as mentioned above, precipitates the product while not precipitating residual precursors and side-products and the antisolvent is easily removed e.g. by evaporation.

### Method for Preparing Optical Metal Oxide Layer

In a third aspect, there is provided a method for preparing an optical metal oxide layer, wherein the method comprises the following steps (a) to (c):
(a) providing a formulation wherein the formulation comprises:

(i) a complex comprising a polyoxometalate of formula (Ia), and a nanoparticle of formula (Ib); and one or more formulation media;
(b) applying the formulation to a surface of a substrate; and
(c) converting the formulation on the surface of the substrate to an optical metal oxide layer.

In a preferred embodiment of the present invention, the formulation provided in step (a) of the method for preparing an optical metal oxide layer is an ink formulation being suitable for inkjet printing. Typical requirements for ink formulations are surface tensions in the range from 20 mN/m to 30 mN/m and viscosities in the range from 5 mPa·s to 10 mPa·s.

In a preferred embodiment of the method for preparing an optical metal oxide layer according to the present invention, the formulation is applied in step (b) to a surface of a substrate by a deposition method. A preferred deposition method is drop casting, coating, or printing. A more preferred coating method is spin coating, spray coating, slit coating, or slot-die coating. A more preferred printing method is flexo printing, gravure printing, inkjet printing, EHD printing, offset printing, or screen printing. Most preferred are spray coating and inkjet printing.

Depending on the specific problem to be solved, the formulation needs to be deposited either as a homogeneous, dense and thin layer covering the entire surface of the substrate by a coating method or the formulation needs to be deposited locally in a structured manner, thus requiring for a printing method. Both, coating and printing methods require formulations to be formulated in an adequate manner to comply with the physico-chemical needs of the respective coating and printing method as well as to comply with certain needs regarding the surface of the substrate to be coated or printed.

Depending on e.g. solid content and trench volume, step (b) is carried out one or more times, such as, e.g. two, three, four, five, six times.

In a preferred embodiment of the method for preparing an optical metal oxide layer according to the present invention, the surface of the substrate is pre-treated by a surface cleaning process. Preferred surface cleaning processes are silicon wafer cleaning processes such as described in W. Kern, The Evolution of Silicon Wafer Cleaning Technology, J. Electrochem. Soc., Vol. 137, 6, 1990, 1887-1892 and in New Process Technologies for Microelectronics, RCA Review 1970, 31, 2, 185-454. Such silicon wafer cleaning processes include wet cleaning process involving cleaning solvents (e.g. isopropanol (IPA)); wet etching processes involving hydrogen peroxide solutions (e.g. piranha solution, SC1, and SC2), choline solutions, or HF solutions; dry etching processes involving chemical vapor etching, UV/ozone treatments or glow discharge techniques (e.g. O₂ plasma etching); and mechanical processes involving brush scrubbing, fluid jet or ultrasonic techniques (sonification). The surface of the substrate can also be pre-treated by silanization or an atomic layer deposition (ALD) process. The pre-treatment of the surface of the substrate serves to modify the hydrophobicity/hydrophilicity of the surface. This can improve the adhesion and filling characteristics of the optical metal oxide layer on the surface of the substrate.

In a more preferred embodiment, a wet cleaning process involving cleaning solvents (e.g. isopropanol (IPA)) is combined with one or more of a wet etching process involving hydrogen peroxide solutions (e.g. piranha solution, SC1, and SC2), choline solutions, or HF solutions; dry etching process involving chemical vapor etching, UV/ozone treatments or glow discharge techniques (e.g. O₂ plasma etching); and mechanical process involving brush scrubbing, fluid jet or ultrasonic techniques (sonification).

In a most preferred embodiment, a wet cleaning process involving cleaning solvents (e.g. isopropanol (IPA)) is combined with a mechanical process involving brush scrubbing, fluid jet or ultrasonic techniques (sonification) and with a wet etching process involving hydrogen peroxide solutions (e.g. piranha solution, SC1, and SC2), choline solutions, or HF solutions;

In a preferred embodiment of the present invention, step (b) of the method for preparing an optical metal oxide layer is carried out several times in succession, preferably 2 to 20 times, more preferably 2 to 10 times, most preferably 2, 3, 4 or 5 times.

In a preferred embodiment of the method for preparing an optical metal oxide layer according to the present invention, the formulation is converted in step (c) on the surface of the substrate to an optical metal oxide layer by exposure to thermal treatment and/or irradiation treatment.

Preferred thermal treatment includes exposure to elevated temperatures as high as 1200° C., preferably up to 600° C., more preferably up to 550° C. and most preferably up to 500° C. Thermal treatment is not limited to any specific thermal treatment methods or times. Depending on the type of substrate and formulation, a person skilled in the art is able to determine suitable thermal treatment methods and times.

Preferred irradiation treatment includes exposure to infrared (IR) light, visible (Vis) light and/or ultraviolet (UV) light. IR light has a wavelength of >800 nm. Vis light has a wavelength from 400 to 800 nm. UV light has a wavelength of <400 nm and may include EUV (extreme UV). Irradiation treatment is not limited to any specific irradiation treatment methods or times. Depending on the type of substrate and formulation, a person skilled in the art is able to determine suitable irradiation treatment methods and times.

In a more preferred embodiment of the method for preparing an optical metal oxide layer according to the present invention, the formulation is converted in step (c) on the surface of the substrate to an optical metal oxide layer by pre-baking (soft baking) at a temperature from 40 to 150° C., preferably from 50 to 120° C., more preferably from 60 to 100° C.; and then baking (hard baking, sintering or annealing) at a temperature from 150 to 600° C., preferably from 250 to 550° C., more preferably from 300 to 500° C.

Soft baking (also referred to as pre-baking) serves the purpose to remove volatile and low boiling components such as e.g. volatile and low boiling formulation media or additives from the drop casted, coated or printed films. Soft-baking is preferably carried out for a period of 1 to 10 minutes. After soft-baking, layers of substrate adhering films of metal oxide precursor or metal oxide precursor mixtures are obtained. The films may still comprise residual formulation media or additives.

In an alternative more preferred embodiment of the method for preparing an optical metal oxide layer according to the present invention, soft-baking can be omitted so that the formulation is converted in step (c) on the surface of the substrate to an optical metal oxide layer directly by baking (hard baking, sintering or annealing) at a temperature from 150 to 600° C., preferably from 250 to 550° C., more preferably from 300 to 500° C.

Baking (hard baking, sintering or annealing) serves the purpose to convert the metal oxide precursor or metal oxide precursor mixture layers on the substrate into a metal oxide layer. Moreover, the final properties of the metal oxide layer may be adjusted by the baking treatment. Baking is preferably carried out for a period of 1 to 300 minutes, preferably 1 to 60 minutes to achieve a refractive index (RI) of >1.8.

Soft-baking and hard-baking may be carried out under ambient atmosphere or atmospheres with increased oxygen content in order to decompose unwanted organic components, which can lead to a lower activation energy when the metal oxide layers are formed.

In a preferred embodiment of the method for preparing an optical metal oxide layer according to the present invention, the substrate is a patterned substrate comprising topographical features and the metal oxide forms a coating layer covering the surface of the substrate and filling said topographical features. As a result, the topographical features are filled and levelled by said metal oxide.

Preferred topographical features include, for example, gaps, grooves, surface relief gratings, trenches and vias. Topographical features may be distributed uniformly or non-uniformly over the surface of the substrate. Preferably, they are arranged as an array or grating on the surface of the substrate. It is preferred that the topographical features have different lengths, widths, diameters as well as different aspect ratios. It is preferred that said topographical features have an aspect ratio of 1:20 to 20:1, more preferably 1:10 to 10:1. The aspect ratio is defined as width of structure to its height (or depth). From the viewpoint of dimension, the depth of the topographical features is preferably in the range from 10 nm to 10 μm, more preferably 50 nm to 5 μm, and most preferably 100 nm to 1 μm.

It is also preferred that the topographical features are inclined at a certain angle, such as an angle from 10 to 80°, preferably from 20 to 60°, more preferably from 30 to 50°, most preferably about 40°. Such inclined topographical features are also referred to as slanted or blazed topographical features.

It may be also necessary to fill topographical features locally with optical metal oxide layer, either completely or to a certain level, but not to cover adjacent surfaces of the substrate, where no topographical features to be filled are available.

Hence, it is preferred that the method for preparing an optical metal oxide layer according to the present invention further comprises the following step (d):
(d) removing a portion of said optical metal oxide layer covering the top of the topographical features, thereby obtaining filled topographical features, wherein an overburden of the optical metal oxide layer on top of said topographical features is reduced, preferably to an overburden of between 0 to 100 nm, more preferably between 0 to 50, and most preferably between 0 to 20 nm.

Step (d) takes place after steps (a) to (c) of the method according to the present invention. Preferably, removing a portion of said optical metal oxide layer covering a top of the topography in step (d) is performed by using a surface cleaning process as described above. Preferred surface cleaning processes are silicon wafer cleaning processes such as described in W. Kern, The Evolution of Silicon Wafer Cleaning Technology, J. Electrochem. Soc., Vol. 137, 6, 1990, 1887-1892 and in New Process Technologies for Microelectronics, RCA Review 1970, 31, 2, 185-454. Such silicon wafer cleaning processes include wet-etching processes involving hydrogen peroxide solutions (e.g. piranha solution, SC1, and SC2), choline solutions, or HF solutions; dry-etching processes involving chemical vapor etching, UV/ozone treatments or glow discharge techniques (e.g. O₂ plasma etching); and mechanical processes involving brush scrubbing, fluid jet or ultrasonic techniques.

The substrate is preferably a substrate of an optical device. Preferred substrates are made of inorganic or organic base materials, preferably inorganic base materials. Preferred inorganic base materials contain materials selected from the list consisting of ceramics, glass, fused silica, sapphire, silicon, silicon nitride, quartz, and transparent polymers or resins. The geometry of the substrate is not specifically limited, however, preferred are sheets or wafers.

In step (b) of the method for preparing an optical metal oxide layer, the formulation is applied on a surface of a substrate, wherein said surface may be either a surface of a base material of the substrate or a surface of a layer of a material being different from the base material of the substrate, wherein such layer has been formed prior to applying said formulation.

In this way, sequences of different layers (layer stacks) can be formed on top of one another. Such layer stacks may be also structured, wherein such structures typically have dimensions in the nanometer scale, at least with respect to diameter, width and/or aspect ratio.

### Use of the Formulation

In a fourth aspect, the invention relates to the use of a formulation for preparing an optical metal oxide layer, wherein the formulation comprises (i) a complex comprising:
a polyoxometalate moiety represented by formula (Ia), and

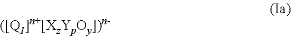

a nanoparticle represented by formula (Ib)

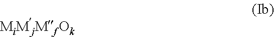

wherein
each Q independently represents a cation, preferably wherein the cation is selected from the group consisting of an ammonium cation, an alkali metal cation, an alkaline earth metal cation,
I is any number in the range from 1 to 20, preferably 1 to 10;
n is a number representing the total positive charge n+ of I cations Q and the corresponding negative charge n− of the polyanion [X_{z}YₚO_{y}];
X is a heteroatom, such as, e.g. B, Si, Ge, P, Al, As, or Sb;
Y is a metal, preferably a transition metal;
z is 0 to 20; p is 1 to 100; and y is 2 to 400;
M, M′ and M,″ each independently, is a metal;
i, j, and f each independently, is an integer or a fraction of 0 to 10; with the proviso that at least one of i, j, and f is not 0; and
k is any number in the range of from 1 to 20, preferably from 1 to 5; and
(ii) one or more formulation media.

### Optical Device

In a fifth aspect, there is provided an optical device comprising an optical metal oxide layer, which is obtainable or obtained by the method for preparing an optical metal oxide layer according to the present invention as described above. It is preferred that the optical device is an augmented reality (AR) and/or virtual reality (VR) device.

### PREFERABLE EMBODIMENTS

Embodiment 1. A formulation for preparing an optical metal oxide layer, wherein the formulation comprises:
(i) a complex comprising
a polyoxometalate moiety represented by formula (Ia), and

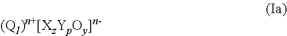

a nanoparticle represented by formula (Ib)

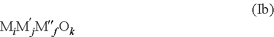

wherein
each Q independently represents a cation, preferably wherein the cation is selected from the group consisting of an ammonium cation, an alkali metal cation, and an alkaline earth metal cation,
I is any number in the range from 1 to 20, preferably 1 to 10;
n is a number representing the total positive charge n+ of I cations Q and the corresponding negative charge n− of the polyanion [X_{z}YₚO_{y}];
X is a heteroatom, preferably B, Si, Ge, P, Al, As, or Sb;
Y is a metal, preferably a transition metal;
z is 0 to 20; p is 1 to 100; and y is 2 to 400;
M, M′ and M,″ each independently, is a metal;
i, j, and f each independently, is an integer or a fraction of 0 to 10; with the proviso that at least one of i, j, and f is not 0; and
k is any number in the range of from 1 to 20, preferably from 1 to 5; and
(ii) one or more formulation media.
Embodiment 2. The complex according to embodiment 1, wherein the complex is not Na₇[PW₁₁O₃₉] complexed to TiO₂, Na₃[PMo₁₂O₄₀] complexed to TiO₂, K₆[P₂W₁₈O₆₂] complexed to TiO₂, K₆[P₂Mo₁₈O₆₂] complexed to TiO₂, or Q_{I}[SiW₁₁O₃₉] complexed to TiO₂, preferably wherein the complex is not Na₇[PW₁₁O₃₉] complexed to TiO₂.
Embodiment 3. The formulation according to embodiment 1, with the proviso that if formula Ib is TiO₂, formula Ia is not Na₇[PW₁₁O₃₉], Na₃[PMo₁₂O₄₀], K₆[P₂Mo₁₈O₆₂], K₆[P₂W₁₈O₆₂], or Q_{I}[SiW₁₁O₃₉], preferably wherein formula Ia is not Na₇[PW₁₁O₃₉].
Embodiment 4. The formulation according to any one of embodiments 1 to 3, wherein the complex is represented by formula (I):

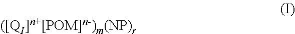

wherein
POM is a polyoxometalate represented by the formula (Ia);
NP is a metal oxide or mixed-metal oxide nanoparticle represented by formula (Ib);
m represents the number of polyoxometalate ligands per nanoparticle, and is any number in the range of from 1 to 5000; and
r is any number in the range from 1 to 20000 and represents an empirical metal-oxide unit in the nanoparticle.
Embodiment 5. The formulation according to any one of the preceding embodiments, wherein M, M′, and M″, each independently, is Ba, Sr, Ti, Zr, Nb, Hf, Ta, Zn, Al, In, Sn, or Ce, preferably Ba(II), Sr(II), Ti(III), Ti(IV), Zr(IV), Nb(V), Nb(III), Hf(IV), Ta(V), Zn(II), Al(III), In(III), Sn(II), Sn(IV) or Ce(IV).
Embodiment 6. The formulation according to any one of the preceding embodiments, wherein M′ is Ti and/or wherein M is Sn.
Embodiment 7. The formulation according to any one of embodiments 1 to 6, wherein i is <1, j is 1−i, and f is 0.
Embodiment 8. The formulation according to any one of embodiments 1 to 6, wherein the nanoparticle is SnO₂, CeO₂, ZrO₂, TiO₂, NbO₂, HfO₂, or Ta₂O₅, preferably wherein the nanoparticle is SnO₂ or TiO₂.
Embodiment 9. The formulation according to any one of embodiments 1 to 7, wherein the nanoparticle is a mixed nanoparticle such as Sn_{0.5}Ti_{0.5}O₂, Sn_{0.25}Ti_{0.75}O₂, Sn_{0.54}Ti_{0.46}O₂, or Sn_{0.13}Ti_{0.87}O₂.
Embodiment 10. The formulation according to any one of the preceding embodiments, wherein X is P, Ar, Sb, S, Si, Ge, B, Be, Mg, Ca, Sr, Mn, Fe, Co, Ni, Cu, Zn, Al, Ga, or is absent, preferably wherein X is P, Si, Al, or is absent.
Embodiment 11. The formulation according to any one of the preceding embodiments, wherein Y is W, Nb, V, Ta, Ti, Zr, Hf, Mo, Zn, In, or Sn, preferably wherein Y is W or Nb.
Embodiment 12. The formulation according to any one of the preceding embodiments, wherein the polyoxometalate moiety is a heteropolyoxotungstate or a polyoxoniobate, preferably wherein the polyoxometalate moiety is Na₇[PW₁₁O₃₉] or K₈[Nb₆O₁₉].
Embodiment 13. The formulation according to any one of the preceding embodiments, wherein the formulation comprises (iii) one or more additive.
Embodiment 14. The formulation according to any one of the preceding embodiments, wherein the one or more additive, each individually, is selected from the group consisting of a further complex as defined in one or more of embodiments 1 to 12, Na₃PW₁₂O₄₀*nH₂O, K₈NbO₁₉*nH₂O, a wetting agent, a dispersion agent, an adhesion promoter, a polymer matrix, and a surfactant.
Embodiment 15. The formulation according to any one of the preceding embodiments, wherein the formulation further comprises Na₃PW₁₂O₄₀*nH₂O or K₈Nb₆O₁₉*nH₂O, and optionally a surfactant such as a polyether modified siloxane.
Embodiment 16. The formulation according to embodiment 14 or embodiment 15 wherein the further complex is Na₇[PW₁₁O₃₉]—TiO₂.
Embodiment 17. The formulation according to any one of embodiments 1 to 16, wherein the formulation medium is water.
Embodiment 18. Use of a formulation according to any one of embodiments 1 to 16 for preparing an optical metal oxide layer.
Embodiment 19. A method for preparing an optical metal oxide layer comprising the following steps:
(a) providing a formulation according to any one of embodiments 1 to 17;
(b) applying the formulation to a surface of a substrate; and
(c) converting the formulation on the surface of the substrate to an optical metal oxide layer.
Embodiment 20. An optical device, preferably an augmented reality and/or virtual reality device, comprising an optical metal oxide layer, wherein the layer is obtainable by a method according to embodiment 19.

The present invention is further illustrated by the examples following hereinafter which shall in no way be construed as limiting. The skilled person will acknowledge that various modifications, additions and alternations may be made to the invention without departing from the spirit and scope of the invention as defined in the appended claims.

### EXAMPLES

### List of Abbreviations

NP nanoparticle
POM polyoxymetalate
Conc. concentration
Cald. calculated
RI refractive index n

### Material and Methods

### Materials

K₇[PW₁₁O₃₉]*nH₂O was prepared following a known procedure. (Haraguchi et al., Inorg. Chem. 2002, 33 (6): 1015-1020.)
K₈[Nb₆O₁₉]*nH₂O was prepared following a known procedure (Kong, X., Hu, D., Wen, P., Ishii, T., Tanaka, Y., & Feng, Q. (2013). Dalton Transactions, 42 (21), 7699-7709. DOI: 10.1039/C3DT00062A.)
Na₃[PW₁₂O₄₀]*nH₂O was prepared following a known procedure (Phillips, M. A. (1950), The preparation of phosphotungstic acid and of sodium and barium phosphotungstates. J. Chem. Technol. Biotechnol., 69:282-284. https://doi.org/10.1002/jctb.5000690906)
Aqueous 25 wt % BYK348 solution was prepared by adding 0.375 g (0.375 ml) of ultrapure water (Milli-Q) to 0.125 g (0.118 ml) of BYK348.
   BYK348 was purchased from BYK-Chemie GmbH.
   10 wt % aqueous Na₃PW₁₂O₄₀*nH₂O solution (PW-A) was prepared by adding 4.5 g of water to 0.5 g of Na₃PW₁₂O₄₀*nH₂O.
   10 wt % aqueous K₈Nb₆O₁₉*nH₂O 10 wt % solution (NbO-A) was prepared adding 4.5 g of water to 0.5 g of K₈Nb₆O₁₉*nH₂O.
   Cellulose dialysis membranes (Spectra/Por 1 Dialysis Membrane MWCO: 6-8,000, nominal flat width 40 mm) were pre-treated before use as per manufacturer.

### General Methods of Detection and Characterization

### 1) Inductively Coupled Plasma Optical Emission Spectrometry (ICP-OES).

Data was acquired using SPECTRO ARCOS FHM22 Instrument (AMETEK®) equipped with vertical plasma torch box (SOP) and analyzed using Smart Analyzer Vision software. Samples were diluted to suit the instrument concentration range and were measured without farther treatment.

### 2) Ellipsometry

Ellipsometry was used to determine layer thickness, refractive index (n) and absorption index (k) of a metal oxide layer. Measurements were performed using an ellipsometer alpha SE from J. A. Woollam and three different angles of incidence (65°, 70° and) 75°. The measurement data was analyzed with software CompleteEase from J. A. Woolam, assuming either full or almost nearly complete transparent behavior above a wavelength of 600 nm and applying Cauchy fitting for obtaining refractive indices (n) as well as absorption indices (k). The optical constants were averaged from three different points measured on the sample either after soft bake or after hard bake.

### Film Preparation:

For the ellipsometry measurements materials were deposited by spin coating at 2000 RPM for 25 sec from water solution with on Si substrate (untreated or piranha treated), soft baked at 100° C. for 1 min, and then hard-baked at 300° C. for 10 min. The film thickness was typically in the range of 35-300 nm.

### Scanning Electron Microscope (SEM)

SEM images were recorded using either a HR-SEM Sirion or Extra-High Resolution Scanning Electron Microscope Magellan 400L (ThermoFisher, former FEI).

### 3) Calculation of Estimated Diameter of POM-NPs

In FIG. 15A is a schematic drawing of a NP (100) with radius R (106) complexed to m POMs (where m=9). The projections (104) of some of the POMs on the NP spherical surface is shown also shown. In FIG. 15B the same projections are shown for the case where the NP's radius is much larger than the POM radius and where the NP is shown as a plane surface to illustrate the packing of POMs spheres.

The following calculation will provide an estimation of the nanoparticle (core) effective radius using the following notations and assumptions:

TABLE 1
Parameters for calculating the estimated diameter of POM-NPs.

| Parameter | Units | parameter | Remark |
|---|---|---|---|
| R | nm | NP radius | Calculated |
| MW^{a} | g/mol | Molecular weight of NP | calculated from formula |
| | | metal oxide | (e.g. 79.87 g/mol for TiO₂) |
| [M] | mol/L | Metal atom NP atoms | measured with ICP-OES |
| | | concentration | |
| ρ^{b} | g/nm³ | Density of Metal Oxide NP | according to crystal |
| | | | structure measured by XRD |
| N_{A} | | Avogadro's number | |
| | | (1/mol) | |
| [POM] | mol/L | POM concentration | Measured the element with |
| | | | ICP-OES; calc. by molar |
| | | | conc. of element divided by |
| | | | number of elements in |
| | | | formula e.g. Nb₆O₁₉ → |
| | | | divide by 6 |
| r_{POM} | nm | POM radius (nm) | computed according to |
| | | | values extracted from |
| | | | academic literature^{c} |
| p_{f} | | Packing factor~0.91 for | https://mathworld.wolfram.com/ |
| | | hexagonal packing | CirclePacking.html |
| NPₘ | g | NP mass | |
| r | | Number of formula units | e.g. number of TiO2 units in |
| | | | a NP |
| m | | Number of POMs covering | |
| | | a NP | |

^{a}for mixed oxide core, the weighted average of the molecular weight was used.
^{b}for NP containing

SnO₂ (casserite) only p was considered to be 6.95 g/cm³ (e.g. Example 1, Example 2);
TiO₂ (anatase) only p was considered to be 3.78 g/cm³ (e.g. Example 9a, Example 9b);
TiO₂ (amorphous) only p was considered to be 3.00 g/cm³ (e.g. Example 6, Example 7);
Mixed Sn/TiO₂ NP an average value of 4.23 g/cm³ for ρ was assumed (e.g. Example 3, Example 4, Example 5, Example 8).
POM effective radius, r_{POM}, was used based on Values taken from Weinstock et al. J. Am. Chem. Soc. 2009, 131, 47, 17412-17422; and Nyman et al., J Clust Sci, 2006, 17:197-219.

The following assumptions are made:
1. The cores (NP) are spherical
2. The number of POMs covering the NP is smaller than the number of “core formula units” (e.g.TiO₂)
3. The curvature of the core NP is not considered in geometric modeling
4. All the metal atoms are in the form of metal-oxide and part of the NP cores
5. All the POM transition metal atoms are in the form of POM and attached to the surface of the NPs

First the mass of a NP is calculated using formula (i) assuming a spherical structure with radius R and density of the relevant crystal structure ρ.

$$N {P}_{m} = \frac{4}{3} π {R}^{3} \cdot ρ \qquad ( i )$$

Afterwards the number of core formula units, r, is calculated by dividing the mass by the molecular weight MW using formula (ii).

$$\frac{N {P}_{m} \cdot {N}_{A}}{M W} = \frac{\frac{4}{3} π {R}^{3} \cdot ρ \cdot {N}_{A}}{M W} \qquad ( ii )$$

Assuming that the core radius is larger than the POM radius (R>r_{POM}) and disregarding curvature of the NP the following is a derivation of the formula for the NP radius.

The number of NPs in 1 liter is calculated by dividing the concentration of the metal element (e.g. Ti), [M], by the number of elements in a single core, r.

The numbers of NPs in 1 liter is given by [M]/r.

The number of POM per 1 liter is given by formula (iii):

$$[ POM ] = m * [ M ] / r \qquad ( iii )$$

Formula (iii) can be used to calculate m by inserting (i) and (ii):

$$m = r \cdot \frac{[ POM ]}{[ M ]} = \frac{\frac{4}{3} π {R}^{3} \cdot ρ \cdot {N}_{A} \cdot [ POM ]}{MW \cdot [ M ]}$$

The surface area of the NP is given by A=4πr² and of the area of a single POM's projection on the core is

$${r}_{P O M}^{2} .$$

The total area of projections of POMs on the surface of the NP is calculated by multiplying the area of a POM by the number of POMs per NP as shown in equation (iv):

$$projections of POMs on cores = \frac{\frac{4}{3} π {R}^{3} \cdot ρ \cdot {N}_{A} \cdot [ POM ]}{MW \cdot [ M ]} \cdot π {r}_{P O M}^{2}$$

The total surface area of the projection of the cores is also given by the surface area of the core multiplied by the packing factor that accounts for the coverage efficiency of closed pack collection of circles on a given area:

$$surface of a N P * ( packing factor ) = ( sum of projections of POMs on NP )$$

and using the formulas above:

$${p}_{f} * 4 π {R}^{2} = \frac{\frac{4}{3} π {R}^{3} \cdot ρ \cdot {N}_{A} \cdot [ POM ]}{MW \cdot [ M ]} \cdot {πr}_{P O M}^{2} .$$

Finally, R is given by:

$$R = \frac{3 \cdot MW \cdot [ M ] * {p}_{f}}{ρ \cdot {N}_{A} \cdot [ POM ] \cdot π {r}_{POM}^{2}} {.}_{}$$

Nanoparticles size is not uniform in this synthesis and can have a variance depending to the exact composition and synthesis method. Therefore in this form of calculation it is assumed that the average parameters including the radius of the NP are considered. In addition, various approximations are made as described above and there is an experimental error in measuring the values [POM] and [M]. Therefore it is expected that the mean radius is within ±30% of the calculated one and in the distribution an even wider variance can be expected.

### General Methods of Preparation

### 1) Surface Pre-Treatment and Formulations Deposition

To prepare piranha-treated substrates, substrates were immersed into H₂SO₄ (conc.) mixed with H₂O₂ (30%) at 3:1 ratio for 20 min, and then washed with distilled water until neutral pH of washing water (at least 9 times). The substrates were dried using air gun.

Coating of wafers (square Si/SiO₂, AF45 glass, or Si/SiN structured substrates of 18×18 mm), was done using a spin coater from Ossila. The spin coating process using planar substrates was as follows: deposition of 0.1 ml of the coating onto wafer followed by a spinning interval of 25 seconds at 2000 rpm. The coating procedure of structured substrates was as follows: deposition of 0.1 ml of the coating onto wafer, retention time of 1 min, followed by a spinning 25 seconds at 2000 rpm. After spin coating, the coated substrates underwent a soft bake at 100° C. for 1 minute for driving out solvent residues, subsequently followed by a cure at elevated temperatures. Usually, however not limited hereto, the coated layers were hard-baked at 300° C., 400° C. and 500° C. for 10 minutes. Soft bake as well as layer cure were performed using high temperature hotplates allowing for reaching temperatures of up to 500° C.

2) Substrates with Trenched Structure

Structured substrates, usually silicon wafers, were used as square-shaped dies with edge length of 1.5 cm to 2 cm. The wafer dies were cut and cleaved from a parent wafer, the parent wafer typically having a diameter of 8″. The structures were created and arranged in a layer stack composed of SiO₂/SiNₓ being deposited onto the wafer surface. Dimensions of the structures (e. g. cross-section width and length of trenches) referred to the architecture of Sematech mask 854. Usually, however not limited hereto, the cross-sectional cleaves perpendicular to trench arrays providing a width of 40 nm to 50 nm were used as trench structures of primary interest to investigate their filling by metal oxides. Besides to the aforementioned, cross-sections of arrays to trenches having widths of 100 nm and 150 nm were used to investigate trench filling by metal oxides.

Structured wafer dies were, unless otherwise mentioned, coated by spin coating. For that purpose, the coating formulation, typically a volume of 0.1 ml per die, was pipetted and casted onto wafer's surface. The wafer die was spun at 2000 rpm for 25 seconds. The soft bake and hard conditions of structured wafer dies was chosen similar or identical to those already mentioned for non-trenched substrates.

### Preparation of POM-Complexed Nanoparticles

### Example 1: Preparation of [α-PW₁₁O₃₉]⁷⁻ Complexed to SnO₂ Nanoparticles

SnCl₄·5H₂O (926 mg, 2.64 mmol) was added as solid to deionized water (198 mL). The pH was adjusted to 4.5 by adding aq. LiOH (160 mM, ca. 66 mL, 10.6 mmol), after which an aqueous solution of K₇[α-PW₁₁O₃₉] (20 mM, 66 mL, 1.32 mmol) was added. The reaction mixture was stirred for two hours at 25° C., transferred to a Teflon-lined 316 stainless steel reaction vessel and heated in an oven (120° C., 24 hours), and then cooled on the bench to room temperature. An optically clear solution containing [α-PW₁₁O₃₉]⁷⁻ complexed to SnO₂ nanoparticles was obtained.

Isolation. Saturated NaCl solution was added to the cooled reaction mixture to a final salt concentration of 1 M, causing complex 1 to reversibly precipitate. The cloudy solution was centrifuged (6000 rpm, 5 min), after which the supernatant was discarded, and the pellet was redissolved in water. Two additional isolation cycles of salt addition, centrifugation, and pellet redissolution were performed. Then the solution was filtered using Millex-HV Syringe Filter Unit (0.45 μm, PVDF, 33 mm) to remove any large impurities. An additional isolation cycle was performed using a minimal amount of water to dissolve the pellet to make a slurry containing [α-PW₁₁O₃₉]⁷⁻ complexed to SnO₂ nanoparticles, with an excess of NaCl.

Purification. The slurry was transferred to a treated cellulose membrane bag which was then placed in a 1 L water bath for dialysis (16 hours, replacing the water once after an hour). After which, a purified, fully dissolved, and concentrated (ca. 1% w/v) solution containing [α-PW₁₁O₃₉]⁷⁻ complexed to SnO₂ nanoparticles was obtained.

Concentration. The dialyzed solution was further concentrated using a gentle stream of compressed air to a concentration of 8.5% (wt %).

A film was prepared as described under the heading “2) Ellipsometry” and the results of the ellipsometry measurements are shown in Table 2.

### Example 2. Preparation of [Nb₆O₁₉]⁸⁻ Complexed to SnO₂ Nanoparticles

Solid SnCl₄·5H₂O (938 mg, 2.68 mmol) was added deionized water (342 mL). The pH was adjusted to 10.5 by adding aq. KOH (400 M, ca. 26.9 mL 10.8 mmol), after which an aqueous solution of K₈Nb₆O₁₉ (20 mM, 66 mL, 1.32 mmol) was added. The reaction mixture was stirred for two hours at 25° C., transferred to a Teflon-lined 316 stainless steel reaction vessel and heated in an oven (120° C., 24 hours), and then cooled on the bench to room temperature. An optically clear solution containing [Nb₆O₁₉]⁸⁻ complexed SnO₂ NPs was obtained.

Isolation, purification and concentration of [Nb₆O₁₉]⁸⁻ complexed SnO₂ NPs were conducted as described above for complex 1, with the distinction of using a saturated solution of KCl instead of NaCl and concentrating to a final concentration of 12 wt %.

A film was prepared as described under the heading “2) Ellipsometry” and the results of the ellipsometry measurements are shown in Table 2.

### Example 3. Preparation of [Nb₆O₁₉]⁸⁻ Complexed to Sn_{0.5}Ti_{0.5}O₂ Nanoparticles

SnCl₄·5H₂O (18.4 mg, 52.5 μmol) was added as solid to deionized water (12.0 mL), followed by the addition of an aqueous solution KOH (400 mM, 0.23 mL, 91 μmol). Then, a freshly prepared solution of titanium-isopropoxide, diluted in isopropanol (40 mM, 4 mL, 160 μmol), was added dropwise under vigorous stirring, resulting in a cloudy white suspension. The solution was stirred for 30 minutes, after which an aqueous solution of K₈[Nb₆O₁₉] (20 mM, 4 mL, 80 μmol) was added. The reaction mixture was stirred for additional two hours at 25° C., transferred to a Teflon-lined 316 stainless steel reaction vessel and heated in an oven (120° C., 20 hours), and then cooled on the bench to room temperature. A solution containing [Nb₆O₁₉]⁸⁻ complexed to Sn_{0.54}Ti_{0.46}O₂ NPs was obtained.

Isolation and purification was conducted as described in example 1, with the distinction of using a saturated solution of KCl instead of NaCl.

Concentration. The dialyzed solution was centrifuged (18000 rcf, 1 hour), such that [Nb₆O₁₉]⁸⁻ complexed to Sn_{0.54}Ti_{0.46}O₂ NPs migrated to the bottom, resulting in a dense, transparent layer, containing high concentration of [Nb₆O₁₉]⁸⁻ complexed to Sn_{0.54}Ti_{0.46}O₂, and a more dilute top layer. The top layer was discarded, and the bottom layer was redissolved with a small amount of water, resulting in a final concentration of [Nb₆O₁₉]⁸⁻ complexed to Sn_{0.54}Ti_{0.46}O₂ NPs of 15.1 wt %.

A film was prepared as described under the heading “2) Ellipsometry” and the results of the ellipsometry measurements are shown in Table 2.

### Example 4. Preparation of [Nb₆O₁₉]⁸⁻ Complexed to Sn_{0.25}Ti_{0.75}O₂ Nanoparticles

[Nb₆O₁₉]⁸⁻ complexed Sn_{0.25}Ti_{0.75}O₂ NPs was synthesized, isolated, purified, and concentrated using the method as described in Example 3, with adjusted quantities of SnCl₄·5H₂O (9.3 mg, 26 μmol), deionized water (11.76 mL), aqueous KOH solution (400 mM, 0.26 mL, 104 μmol), and an amount of K₈[Nb₆O₁₉] (4 mL, 80 μmol).

The product was concentrated to 9.2 wt % at a pH 10.

A film was prepared as described under the heading “2) Ellipsometry” and the results of the ellipsometry measurements are shown in Table 2. (Example 4a)

Another film was prepared as under the heading “2) Ellipsometry”, but hard-baked at 200° C. instead of 300° C. The results of the ellipsometry measurements are shown in Table 2. (Example 4b)

### Example 5. [Nb₆O₁₉]⁸⁻ Complexed to Sn_{0.13} Ti_{0.87}O₂ Nanoparticles

[Nb₆O₁₉]⁸⁻ complexed Sn_{0.13}Ti_{0.87}O₂ NPs was synthesized, isolated, purified and concentrated using the method described in Example 3, with adjusted quantities of SnCl₄·5H₂O (7.2 mg, 20 μmol), deionized water (11.42 mL), aqueous KOH solution (400 mM, 0.58 mL, 230 μmol), and the same amount of K₈[Nb₆O₁₉] (4 mL, 80 μmol).

The solution comprising [Nb₆O₁₉]⁸⁻ complexed Sn_{0.13}Ti_{0.87}O₂ was concentrated to a concentration of 17.7 wt %. Afterwards, the solution was diluted four times, resulting in a final concentration of 4.4 wt %.

A film was prepared as described under the heading “2) Ellipsometry” and the results of the ellipsometry measurements are shown in Table 2.

### Example 6. Preparation of [Nb₆O₁₉]⁸⁻ Complexed to TiO₂ Nanoparticles

A solution of aqueous KOH (400 mM, 4.5 mL, 1.8 mmol) was added to deionized water (178.3 mL), followed by a dropwise addition of a freshly prepared solution of titanium-isopropoxide diluted in isopropanol (40 mM, 59.4 mL, 2.38 mmol) under vigorous stirring, resulting in a slightly cloudy white suspension. After which, a solution of aqueous K₈[Nb₆O₁₉] (20 mM, 59.4 mL, 1.19 mmol) was added. The reaction mixture was then refluxed (80° C., 24 hours) to yield a solution containing complex 6. Isolation and purification were conducted in a similar manner described for example 1, with a distinction of using a saturated solution of KCl instead of NaCl; concentrated solution of the product was achieved using the concentrating method described for example 3.

The final concentration of the solution containing [Nb₆O₁₉]⁸⁻ complexed to TiO₂ nanoparticles was 18.6 wt %.

A film was prepared as described under the heading “2) Ellipsometry” and the results of the ellipsometry measurements are shown in Table 2. (Example 6a).

The solution containing [Nb₆O₁₉]⁸⁻ complexed to TiO₂ nanoparticles (18.6% w/v) was diluted twice to a concentration of 9.8 wt %.

A film was prepared as described under the heading “2) Ellipsometry” and the results of the ellipsometry measurements are shown in Table 2. (Example 6b).

### Example 7. Preparation of [Nb₆O₁₉]⁸⁻ Complexed to TiO₂ Nanoparticles

Synthesis, isolation, purification, and concentration were conducted using the protocol describe in Example 6, but instead of reflux, the reaction was heated hydrothermally. After the addition of 20 mM K₈[Nb₆O₁₉] solution, the reaction mixture was stirred for one hour at 25° C., transferred to a Teflon-lined 316 stainless steel reaction vessel and heated in an oven (180° C., 20 hours), and then cooled on the bench to room temperature.

A solution containing [Nb₆O₁₉]⁸⁻ complexed to TiO₂ NPs was obtained (5.2 wt %).

A film was prepared as described under the heading “2) Ellipsometry” and the results of the ellipsometry measurements are shown in Table 2.

### Example 8. Preparation of [α-PW₁₁O₃₉]⁷⁻ Complexed to Sn_{0.13}Ti_{0.87}O₂ Nanoparticles

Solid SnCl₄·5H₂O (103 mg, 0.294 mmol) was added to deionized water (293 mL). Then, a freshly prepared solution of titanium-isopropoxide in isopropanol (10% v/v, 9 mL, 3.1 mmol) was added dropwise under vigorous stirring, resulting in a cloudy white suspension. The pH was adjusted to 4.5 by adding aqueous KOH (0.4 M, ca. 3 mL, 1.2 mmol), after which K₇[α-PW₁₁O₃₉]*nH₂O (3.71 g, 1.17 mmol) was added as a crystalline solid. The reaction mixture was stirred for three hours at 25° C., transferred to a Teflon-lined 316 stainless steel reaction vessel and heated (120° C., 17 hours), and then cooled on the bench to room temperature. A solution containing [α-PW₁₁O₃₉]⁷⁻ complexed to Sn_{0.13}Ti_{0.87}O₂ nanoparticles was obtained.

Isolation and purification of the sample were conducted as described in Example 1.

Concentration. The solution was concentrated to a final concentration of 9.4 wt % by following the method described in Example 3.

The optical properties of [PW₁₁O₃₉]⁷⁻ complexed to Sn_{0.13}Ti_{0.87}O₂ nanoparticles were measured after soft-bake of 100° C. (8a) for one minute and after subsequent heating periods (hard-baking) of 10 minutes at 300° C. (8b), 400° C. (8c) and 500° C. (8d). The results of the ellipsometry measurements are shown in Table 2.

It seems that the optimum is reached at 300° C. with maximal RI.

The shrinkage between 100° C. for 1 minute to 300° C. is about 5%

### Example 9a-b. Preparation of [α-PW₁₁O₃₉]⁷⁻ Complexed to TiO₂ Nanoparticles

### Example 9a

Into a 369 mL deionized water, a freshly prepared solution of 10% titanium-isopropoxide in isopropanol (8.9 mL, 3.0 mmol) was added dropwise under vigorous stirring, resulting in a cloudy white suspension. After which, K₇[α-PW₁₁O₃₉]*nH₂O (4.79 g, 1.51 mmol) was added as a crystalline solid. The reaction mixture was then stirred for 10 minutes at 25° C., transferred to a Teflon-lined 316 stainless steel reaction vessel and heated in an oven (170° C., 20 hours), and then cooled on the bench to room temperature. An optically clear solution containing [α-PW₁₁O₃₉]⁷⁻ complexed TiO₂ NPs was obtained.

Isolation and purification of [α-PW₁₁O₃₉]⁷⁻ complexed to TiO₂ nanoparticles were conducted as described for example 1.

Concentration. A concentrated solution was obtained following the method described in example 3, to yield 10.7 wt %.

A film was prepared as described under the heading “2) Ellipsometry” and the results of the ellipsometry measurements are shown in Table 2.

### Example 9b

A freshly prepared solution of titanium-isopropoxide, diluted in isopropanol (40 mM, 59.4 mL, 2.38 mmol) was added dropwise under vigorous stirring to deionized water (178 mL), resulting in a cloudy white suspension. After which an aqueous solution of K₇[α-PW₁₁O₃₉] (20 mM, 59.4 mL, 1.19 mmol) was added. The reaction mixture was then stirred for an hour at 25° C., transferred to a Teflon-lined 316 stainless steel reaction vessel and heated in an oven (180° C., 20 hours), and then cooled on the bench to room temperature. An optically clear solution containing [α-PW₁₁O₃₉]⁷⁻ complexed TiO₂ NPs was obtained.

Isolation and purification of the solution were conducted as described for example 1. A concentrated solution of 10.1 wt % was achieved using the concentrating method described for example 3.

A film was prepared as described under the heading “2) Ellipsometry” and the results of the ellipsometry measurements are shown in Table 2.

TABLE 2
Summary of ellipsometry data (thickness, n & k), material concentration
in aqueous solution and calculated estimated diameter.

| | Conc. | Calc d | Thickness | | |
|---|---|---|---|---|---|
| Example # | [wt %] | [nm] | [nm] | n @ 520 nm | k @ 460 nm |
| 1 | 8.5 | 2.1 | 102 | 1.804 | 0.0021 |
| 2 | 12 | 3.2 | 305 | 1.836 | 0.0024 |
| 3 | 15.1 | 4.9 | 112 | 1.915 | 0.0010 |
| 4a | 9.2 | 4.3 | 92 | 1.968 | 0.0031 |
| 4b | 9.2 | 4.3 | 94 | 1.943 | 0.0032 |
| 5 | 4.4 | 3.9 | 54 | 1.922 | 0.0286 |
| 6a | 18.6 | 8.5 | 131 | 1.917 | 0.015 |
| 6b | 9.8 | 8.5 | 55 | 1.990 | 0.003 |
| 7 | 5.2 | 5.4 | 146 | 1.880 | 0.0009 |
| 8a | 9.4 | 5.5 | 186 | 1.792 | 0.0013 |
| 8b | 9.4 | 5.5 | 1788 | 1.812 | 0.0021 |
| 8c | 9.4 | 5.5 | 173 | 1.805 | 0.0023 |
| 8d | 9.4 | 5.5 | 171 | 1.796 | 0.0019 |
| 9a | 10.7 | 3.7 | 120 | 1.848 | 0.0016 |
| 9b | 10.1 | 3.4 | 146 | 1.915 | 0.0016 |

As can be seen from Table 2, the complex obtained in Example 4 shows the highest refractive index among the complexes with a varying ratio of Sn to Ti suggesting that the optimal element ratio between Sn and Ti is 0.25 to 0.75. In addition, example 8 shows that an optimum appears to be reached at 300° C. The shrinkage between 100° C. for 1 minute to 300° C. is about 5%.

The presence of both counter ions “K” and Na” in Examples 1, 8, and 9 can easily be explained by looking at the synthetic route. It will be appreciated that “K” is a left-over residue from the precursor K₇[α-PW₁₁O₃₉]*H₂O used for the synthesis of the corresponding POM-NPs.

TABLE 3
ICP-OES measurements of purified materials.

| Example | K | Na | Nb | Sn | Ti | W |
|---|---|---|---|---|---|---|
| number | [ppm] | [ppm] | [ppm] | [ppm] | [ppm] | [ppm] |
| 1 | 0.31 | 3.99 | | 83.73 | | 67.36 |
| 2 | 6.20 | | 28.53 | 61.18 | | |
| 3 | 5.88 | | 16.87 | 26.73 | 8.45 | |
| 4 | 10.82 | | 23.96 | 16.08 | 18.45 | |
| 5 | 24.65 | | 48.96 | 16.62 | 45.14 | |
| 6 | 56.71 | | 31.19 | | 56.37 | |
| 7 | 7.30 | | 10.82 | | 12.48 | |
| 8 | | 2.28 | | 8.96 | 25.01 | 36.95 |
| 9a | 0.40 | 1.65 | | | 36.34 | 40.59 |
| 9b | 0.49 | 3.91 | | | 43.09 | 52.58 |

The above examples show that the technical objects of the present invention are achieved.

### Alternative Solvent-Based Purification Method

Synthesis Protocol for the Preparation of [Nb₆O₁₉]⁸⁻ Complexed SnₓTi₁₋ₓO₂ Nanoparticles

SnCl₄*H₂O (140 mg, 399 μmol) was added as a solid to deionized water (173 mL). A KOH solution (1M, 1.4 mL, 1.4 mmol) was added to the mixture to adjust the pH to 10.3. The addition of both a freshly prepared titanium isopropoxide solution (40 mM, 730 μL, 2.49 mmol titanium isopropoxide, diluted with 61.52 mL isopropanol) and an aqueous solution of K₈[Nb₆O₁₉] (1.686 g, 1.25 μmol, dissolved in 62.25 mL water) were carried out simultaneously to the tin solution while stirring vigorously, in a slow and steady stream (approximately 30 seconds). The reaction mixture was then stirred for approximately 3 hours before the mixture was transferred to a Teflon-lined 316 stainless steel reaction vessel and heated in an oven at 120° C. for 20 hours. The reaction vessel was then cooled to room temperature, yielding a solution containing [Nb₆O₁₉]⁸⁻ complexed to SnₓTi₁₋ₓO₂ nanoparticles.

### Precipitation-Based Purification Method (Purification Method 1)

Purification method 2 involves precipitating product from the reaction mixture by adding a saturated KCl solution until a concentration of 1 M KCl is reached. At these conditions, the nanocrystals aggregate reversibly and precipitate, while most of the molecular clusters remain in solution. The precipitate is separated from the supernatant through centrifugation and decantation and can then be redissolved in water, using the same volume of solvent that of the reaction itself, or in a volume about one-sixth of the reaction volume. The precipitation, centrifugation, and redissolution steps (one purification cycle) is repeated three times.

The resultant nanocrystal solution will contain excess KCl, which limits the solubility of the product to ca. 1% wt. To enhance solubility, 18 hours of dialysis is performed to remove excess KCl and some of the K⁺ counter ions of the hexaniobate ligands, leaving 6 to 8 K⁺ ions per ligand. Remaining counter-cations are protons (0 to 2H⁺). This removal of KCl enables further concentration by air evaporation of the aqueous solution to greater than 5% wt. product.

Solvent-Based Purification Method for the Removal of Molecular by-Products Through Addition of Solvent (Purification Method 2)

In a typical procedure, methanol is added until 10% vol. is reached so that a mixed solvent system of methanol, isopropanol, and water is obtained. This step is then followed by centrifugation and redissolution of the so-obtained pellet in water or filtration (depending on the scale).

### Results

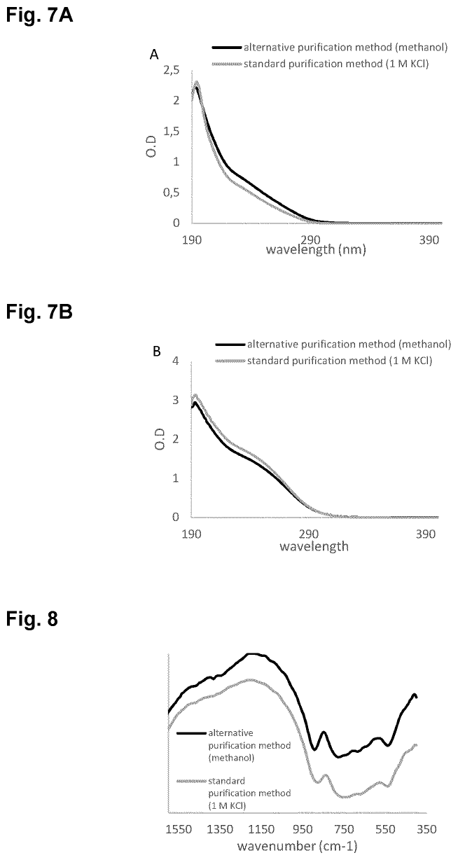

The dissolved pellets and the supernatant solutions obtained after the two purification methods (purification method 1 and purification method 2) were compared after single precipitation, isolation and redissolution cycle using data from UV-Vis, FTIR and ICP spectroscopies (FIGS. 7A-B and 8, and Table 4).¹

FIGS. 7A-B shows a comparison of UV-VIS spectra of diluted samples of the supernatant solutions (A) and of the dissolved product (B) obtained using purification method 1 and 2.

FIG. 8 shows the FT-IR spectrum of dried samples of products obtained using the purification methods 1 and 2.

The resulting molar ratios between the elements of the isolated products obtained by ICP-OES measurements are shown in Table 4.

TABLE 4
Molar ratios between elements in isolated products, measured by
ICP-OES. The data were obtained after only one purification cycle,
which means that the so-obtained nanoparticle may not have been
fully purified. Additional purification cycles may require a different
solvent system to separate the remaining by-products.

| Sample | K | Nb | Sn | Ti |
|---|---|---|---|---|
| Purification method 1 | 2.54 | 1 | 0.18 | 0.96 |
| Purification method 2 | 0.91 | 1 | 0.19 | 0.91 |

### “Combination Method” (Combining Purification Method 1 and 2)

After purification via purification method 1, the solution was precipitated once more using KCl, followed by centrifugation. The so-obtained pellet was dispersed into a 1:1 water-methanol mixture—⅕^{th} of the initial sample volume-centrifuged and the pellet redissolved in pure water.

Table 5 shows the molar ratios between the elements of the isolated products, measured by ICP-OES.

TABLE 5
Molar ratios between elements in isolated
products, measured by ICP-OES.

| Sample | K | Nb | Sn | Ti |
|---|---|---|---|---|
| Purification method 1 | 13.85 | 1 | 0.43 | 1.53 |
| Purification method 2 | 1.43 | 1 | 0.41 | 1.50 |

The combined method sample had an excess of 0.6 K⁺ ions per [Nb₆O₁₉]⁸⁻ cluster, while the standard method sample had an excess of 75 K⁺ ions per [Nb₆O₁₉]⁸⁻ cluster.

The results of Table 4 and Table 5 can further be optimized by repeating purification cycles, adjusting the nature of the added solvents or relative ratios of solvent mixtures, or by reducing the pH to control the protonation states of the ligands in the product, which affects solubility and separation upon additions of organic solvents.

### Additional Solvent Systems:

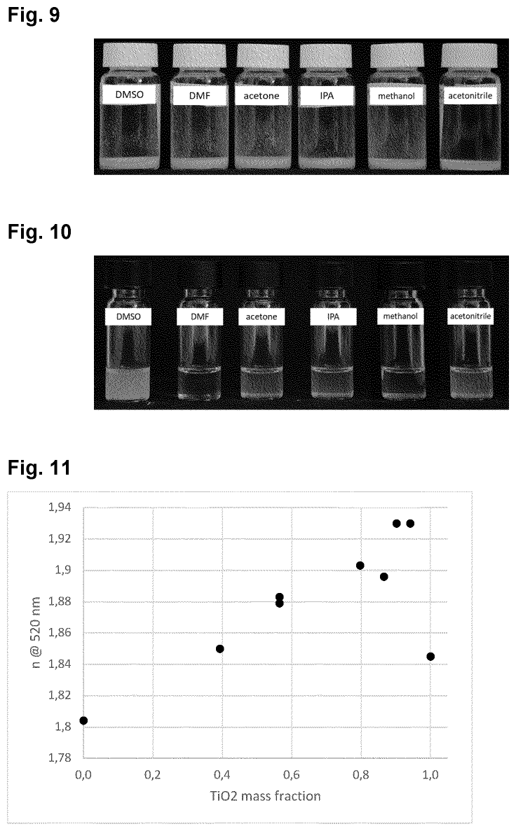

The addition of further solvents to the isopropanol-water mixture may also be considered. For instance, FIG. 9 shows reaction mixtures after adding 10% (v/v) of additional solvent (such as, e.g. DMSO, DMF, acetone, methanol, acetonitrile), creating mixed organic-water solvent systems.

FIG. 10 shows pure solutions of K₈Nb₆O₁₉ in mixed solvent systems of the added solvent, isopropanol, and water.

Preparation of Formulations Containing Complexes of Different Sizes or with Additional Polyoxometalate Ligands

The purpose of the following experiments was to test whether adding smaller POM-NP complexes to larger POM-NP complexes leads to coatings having increased refractive indexes.

### General Method

The materials are vortex mixed 15 seconds at room temperature. When necessary, the materials are diluted in water by heating at 50° C. for 10 minutes and using vortex mixing.

### Example M1

An aqueous solution of “PW—SnO₂” (8.5 wt %, Example 1) was mixed with an aqueous solution of “PW—TiO₂” (10.7 wt %, Example 9a) in the amounts as indicated in Table 4.

The results of the ellipsometry measurements are shown in Table 6.

TABLE 6
Mixtures of PW-SnO₂ (8.5 wt %) and PW-TiO₂ (10.7
wt %) and resulting refractive indexes

| Volume | Volume | weight fraction | |
|---|---|---|---|
| PW-TiO₂, [μl] | PW-SnO₂, [μl] | PW-TiO₂ | n @ 520 nm |
| 100 | 0 | 1.00 | 1.848 |
| 0 | 100 | 0.00 | 1.804 |
| 100 | 8 | 0.94 | 1.930 |
| 100 | 14 | 0.90 | 1.930 |
| 100 | 20 | 0.87 | 1.896 |
| 100 | 33 | 0.80 | 1.903 |
| 100 | 50 | 0.72 | 1.883 |
| 50 | 50 | 0.56 | 1.879 |
| 50 | 100 | 0.39 | 1.850 |

Table 6 shows that mixing PW—TiO₂ with PW—SnO₂ in various ratios results in a higher refractive index compared to the pure PW—TiO₂ or PW—SnO₂ material, respectively. Adding a small amount of PW—SnO₂ to PW—TiO₂ appears to be particularly beneficial for achieving a higher refractive index with the highest refractive index being achieved by 0.90-0.94 weight fraction of PW—TiO₂.

FIG. 11 shows the refractive index dependence on PW—TiO₂ weight fraction for the PW—TiO₂/PW—SnO₂ mixture.

### Example M2

An aqueous solution of “PW—TiO₂” (10.7 wt %, Example 9a) was mixed with an aqueous solution of “PW-A” (10 wt %) in the amounts as indicated in Table 7.

The results of the ellipsometry measurements are shown in Table 7.

TABLE 7
Mixtures of PW-TiO₂ and PW-A

| Weight fraction PW-A | N @ 520 nm | k @ 460 nm |
|---|---|---|
| 0.00 | 1.845 | 0.0016 |
| 0.05 | 1.871 | n/a |
| 0.10 | 1.907 | n/a |
| 0.19 | 1.97 | 0.001 |
| 0.31 | 2.074 | 0.007 |
| 0.48 | 2.062 | 0.006 |
| 0.65 | 2.018 | 0.01 |

Increasing the amount of PW results in increase of refractive index up to 2.074 at 0.31 PW-A weight fraction. Additional amounts of PW-A decreases the refractive index at a smaller slope compared with the increase for weight fraction<0.31.

A refractive index of 2.093 was achieved with a different batch of PW—TiO₂ at a weight fraction of 0.35. The so-prepared film also had an extinction coefficient of 0.003.

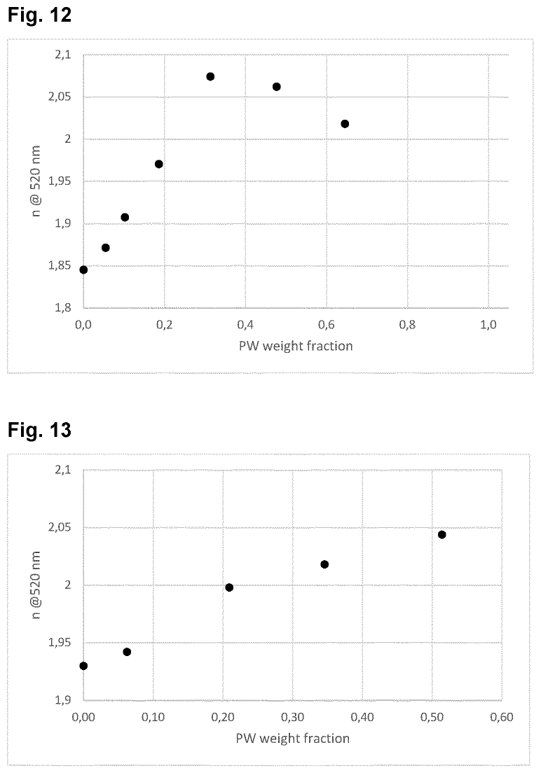

The refractive index of the mixture comprising PW—TiO₂ and PW-A are shown in FIG. 12 as a function of PW—TiO₂ wt % content measured on a thin film deposited on a Si substrate and hard-baked at 300° C.

### Example M3

An aqueous solution of “PW—SnO₂” (8.5 wt %, Example 1) was mixed with an aqueous solution of “PW—TiO₂” (10.7 wt %, Example 9a) to obtain a weight fraction of PW—TiO₂ of 0.94 (see Table 3). In addition, an aqueous solution of PW-A (9.5 wt %) was added in the amounts indicated in Table 8.

TABLE 8
Refractive indexes after adding different amounts
of PW-A in water to a stock solution of PW-TiO₂/
PW-SnO₂ at 13/1 volume ratio in water.

| PW-A weight fraction | N @ 520 nm | k @ 460 nm |
|---|---|---|
| 0 | 1.930 | 0 |
| 0.062 | 1.942 | 0.0086 |
| 0.209 | 1.998 | 0.0091 |
| 0.346 | 2.018 | 0.0006 |
| 0.514 | 2.044 | 0.0061 |

As can be seen in Table 8, adding PW-A to mixture of PW—TiO₂/PW—SnO₂ leads to an increase in refractive index.

FIG. 13 shows the refractive index of the PW—TiO₂/PW—SnO₂ mixture and varied amount of PW-A added.

### Example M4

An aqueous solution of “NbO—Sn_{0.25} Ti_{0.75}O₂” (9.2 wt %, Example 4) was mixed with a solution “NbO-A” (10 wt %) in the amounts as indicated in Table. From the resulting formulations films were prepared. The results of the ellipsometry measurements are shown in Table 9.

TABLE 9
Mixing volumes of NbO—Sn_{.25}Ti_{.75}O₂ (9.2 wt %) solution
with NbO—A solution and ellipsometry results.

| | Volume of | Volume of | Wt % ratio | | N @ | k @ |
|---|---|---|---|---|---|---|
| | NbO—Sn_{.25}Ti_{.75}O₂ | NbO—A | NbO—Sn_{.25}Ti_{.75}O₂)/ | Thickness, | 520 | 460 |
| | [μl] | [μl] | NbO—A | nm | nm | nm |
| M4.1^{a} | 72 | 25 | 3.6 | 85.4 | 1.901 | 0.0077 |
| M4.2^{a} | 57 | 40 | 1.8 | 76.9 | 1.997 | 0.0058 |
| M4.3^{a} | 41 | 57 | 0.9 | 111.7 | 1.691 | 0.0749 |
| M4.4^{b} | 72 | 25 | 3.6 | 75.2 | 1.980 | 0.0068 |
| M4.5^{b} | 57 | 40 | 1.8 | 71.4 | 2.033 | 0.0046 |
| M4.6^{b} | 41 | 57 | 0.9 | 99.2 | 1.802 | 0.0265 |

^{a}Hard-baked at 300° C.
^{b}Hard-baked at 400° C.

For both baking temperatures of 300° C. and 400° C. the wt % ratio NbO—Sn_{0.25} Ti. 7502/NbO-A of 1.8/1 resulted in films with higher refractive index: 1.997 for 300° C. and 2.033 for 400° C.

The extinction parameter k is significantly higher for high content of NbO-A POM.

Film prepared from pure NbO—Sn_{0.25}Ti_{0.75}O₂ had thickness 92 nm, RI 1.968 and k 0.0031. The addition of NbO-A POM increased the RI.

### Example M5 (Mixing Material 7 and Material 15)

An aqueous solution of “NbO—TiO₂” (5.2 wt %, Example 7) was mixed with a solution “NbO-A” (10 wt %) in the amounts as indicated in Table.

TABLE 10
Mixing NbO—TiO₂ with NbO—A and optical properties
of the films deposited from the resulting formulations
and baked at 300° C. for 10 min.

| Volume of | Volume of | wt % ratio | | n @ | k @ |
|---|---|---|---|---|---|
| NbO—TiO₂ | NbO—A | NbO—TiO₂/ | Thickness | 520 | 460 |
| [μl] | [μl] | NbO—A | [nm] | nm | nm |
| 87.4 | 12.6 | 3.6 | 92.7 | 1.982 | 0.0049 |
| 77.6 | 22.4 | 1.8 | 101.9 | 1.992 | 0.0000 |
| 63 | 37 | 0.9 | 162.1 | 1.820 | 0.0103 |

Compared with the result obtained in Example 7 (RI=1.880, k=0.0009) the addition of POM increases the RI. As can be seen in Table 10, the highest RI was achieved for a wt % ratio (NbO—TiO₂/NbO-A) having RI=1.992.

### Example M6

An aqueous solution of “PW—Sn_{0.13}Ti_{0.87}O₂” (9.4 wt %, Example 8) was mixed with a solution “PW-A” (10 wt % of PW-A in water) in the amounts as indicated in Table 11.

TABLE 11
Mixing volumes of PW-Sn_{.12}Ti_{.87}O₂ with PW-A and optical
properties of the films deposited from the resulting
formulations, baked at 300° C. for 10 min.

| Volume of | | wt ratio | | | |
|---|---|---|---|---|---|
| PW- | | PW- | Thick- | N @ | k @ |
| (TiO2—SnO2), | Volume of | (TiO2—SnO2)/ | ness, | 520 | 460 |
| μl | PW, μl | PW | nm | nm | nm |
| 75 | 25 | 2.8 | 83.9 | 1.982 | 0.0055 |
| 66.7 | 33.3 | 1.9 | 75.1 | 2.027 | 0.0053 |
| 50 | 50 | 0.9 | 68.3 | 1.989 | 0.0075 |

The extinction parameter k is not significantly higher for high content of NbO-A ligand as was the case for the higher SnO₂ content particles.

TABLE 12
Selected ellipsometry data of the individual materials
mixed with POM or with another POM-NP (Examples M1-M6).

| | | | Thick- | n @ | k @ |
|---|---|---|---|---|---|
| | | | ness | 520 | 460 |
| Ex. # | Material 1 | Material 2 | [nm] | nm | nm |
| M1 | PW-SnO₂ | PW-TiO₂ | | 1.930 | N/A |
| | (Example1) | (Example 9) | | | |
| M2 | PW-TiO₂ | PW-A | | 2.074 | 0.007 |
| | (Example 9) | | | | |
| M3 | PW-SnO₂/PW-TiO₂¹ | PW-A | | 2.044 | 0.0061 |
| | (Example M1) | | | | |
| M4 | NbO—Sn_{.25}Ti_{.75}O₂ | NbO—A | 76.9 | 1.997 | 0.0058 |
| | (Example 4) | | | | |
| M5 | NbO—TiO₂ | NbO—A | 101.9 | 1.992 | N/A |
| | (Example 7) | | | | |
| M6 | PW-Sn_{.13}Ti_{.87}O₂ | PW-A | 75.1 | 2.027 | 0.0053 |
| | (Example 8) | | | | |

¹TiO₂ @ 0.94 wt fraction

The refractive index n and extinction parameter k shown in table 12 were all measured after soft-bake at 100° C. followed by hard-bake at 300° C. This temperature was chosen since it has advantage for device manufacturing utilizing these formulations. However, higher refractive values n may be achieved when baking at higher temperatures as seen in examples M4.4, M4.5 and M4.6.

### Conclusion

Selected results from examples M1 to M6 are summarized in Table 12. As can be seen, the addition of a small amount (6 wt %) of a smaller sized POM-NP to a larger sized POM-NP yields an unexpected increased in refractive index (Table 10. M1). The addition of POM ligand to a POM-NP is also beneficial in all the examples tested (Table 10. M2-6) Adding PW-A to a solution of PW—SnO₂/PW—TiO₂ (PW—SnO₂ 6%) further increases the refractive index to 2.04 with low k (Table 12: M3).

### Trenches Filling Experiment

### Example T1: PW—SnO₂

The solution obtained in Example 1 was diluted to a concentration of 5 wt % PW—SnO₂ in water. The 5 wt % solution was used to deposit a trench sample following the procedure described in “Substrates with trenched structures” above.

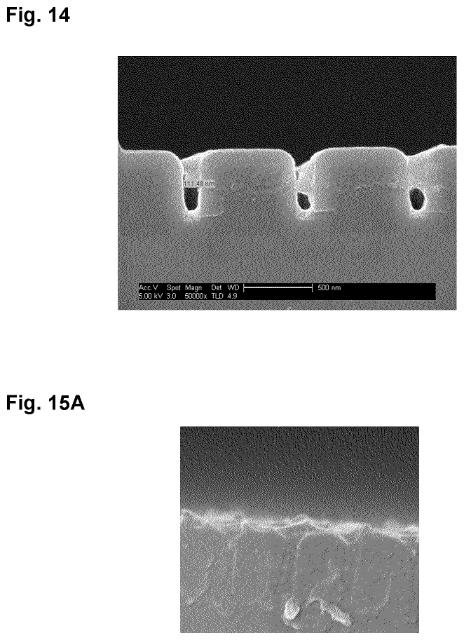

Briefly, the solution comprising PW—SnO₂ (5 wt %, 0.1 mL) was deposited on Piranha treated Si substrate followed by spinning at 2000 rpm for 25 seconds. The substrate was soft-baked at 100° C. for 1 min, and then hard-baked at 300° C. for 10 min. SEM images of a cross section are shown in FIG. 14. As shown in FIG. 14, large voids are formed in the trenches. This can be result of incomplete filling of the gaps due to poor penetration and poor adhesion of the POM-NP to the trench surface during the heating stage.

### Example T2-A: BYK348 Additive with PW—SnO₂

An aqueous solution of PW—SnO₂ (8.5 wt %; Example 1) was mixed an aqueous solution of BYK348 (0.5 wt %) in water.

After mixing, a drop was casted on a SiN surface with trench structure. The trench substrate was prepared as described above (see section “Substrates with trenches substrates”). The obtained SEM image is shown in FIG. 15A. It can be seen that a complete trench fill is obtained

### Example T2-B: BYK348 Additive with PW—SnO₂

To study the optical properties of films containing BYK348 additive a formulation of 8.5 wt % PW—SnO₂ with 0.5 wt % BYK348 in water was prepared.

Additional films were deposited on trench substrates using spin coating technique. For this formulation, the trenches were partially filled and voids appeared after hard-baking at 200° C. as shown in FIG. 15B.

It can be seen in the SEM image in FIG. 15B that there is only partial filling (~50%) and some small side voids appear, but the filling is better than compared with the one shown in FIG. 14.

### Example T2-C: BYK348 Additive with Example #2 Ellipsometry

An aqueous solution of [Nb₆O₁₉]-8 complexed to SnO₂ NPs (12 wt %, as described in Example 2) was mixed with aqueous solution containing BYK348 to reach 0.5 wt % of the BYK348.

A Si wafer was used as a substrate for the film end and the refractive index and the extinction coefficient were measured after the film passed soft-bake at 100° C. for 1 min and hardbake at 300° C. for 10 min.

The so-obtained material had a lower refractive index compared to the material obtained in Example 2.

The results of the ellipsometry measurements are shown in Table 13.

### Example T3

A formulation of PW—SnO₂ (Example 1) with the POM additive PW-A at a weight ratio of 0.85/1 was prepared similar to the technique described in Example M2. Taking 100 μL of the PW—SnO₂ 8.5 wt % material and 100 UL of the PW-A material.

The formulation was deposited as a thin film on a Si substrate and after 100° C. 1 minute soft-bake and 10 minutes hardbake at 300° C.

The results of the ellipsometry measurements are listed in Table 13.

The formulation was deposited by spin coating on a trench sample and the SEM image of the cross section is shown in FIG. 16.

This formulation resulted in a better trench fill than the pure material as described in example 1 (PW—SnO₂), similar to trench fill after spin coating with BYK348. However, BYK348 decreases RI.

### Example T4: NbO—Sn_{0.25}Ti_{0.75}O₂+NbO-A

The formulation is described in Example M4 above.

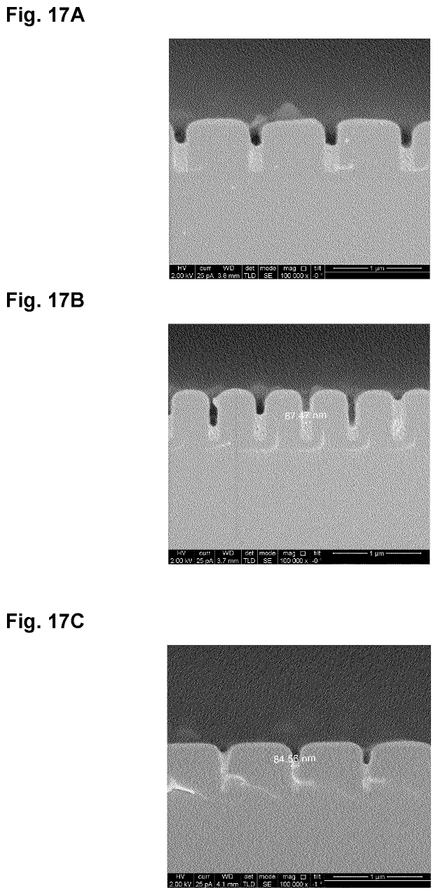

Spin coating was applied to the trench samples after soft-bake at 100° C. for 1 min a SEM image below of a 114 nm trench (FIG. 17A) and 87.5 (FIG. 17B) width shows partial filling.

After hard-baking at 300° C. for 10 min (after soft-bake of 100° C. for 1 minute) 84 nm trench width the filling was partial (FIG. 17C).

### Example T5 NbO—Sn_{0.25}Ti 75O₂+NbO-A

In order to obtain full trench filling a two-layer deposition technique was implemented using the same formulation as in Example T4.

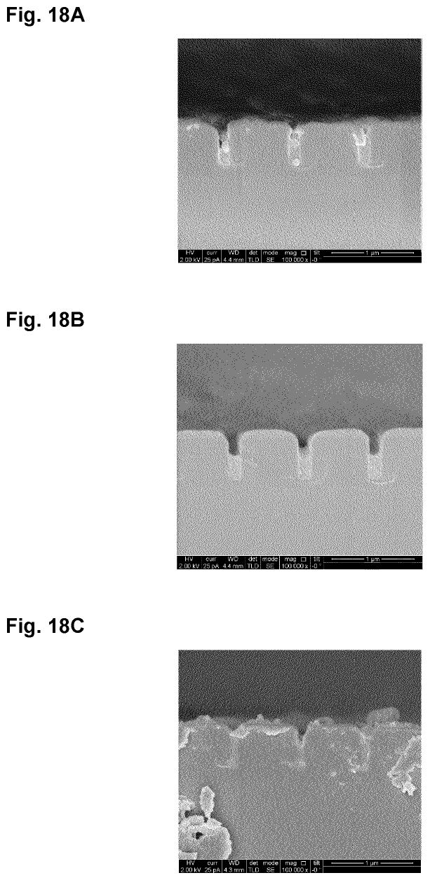

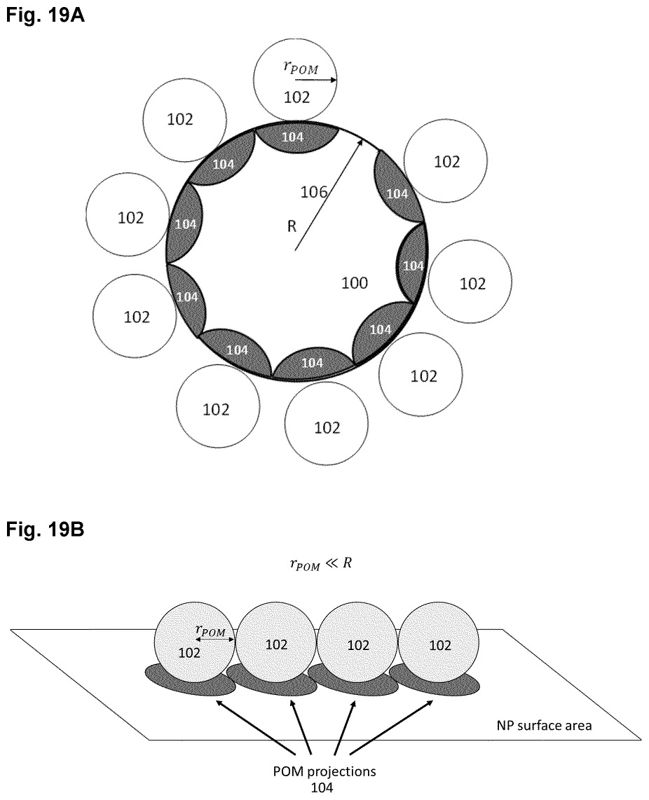

The first sample was prepared with a single soft-bake step (100° C. for one minute) after both layers are deposited. FIGS. 18A and 18B shows the surface feature filling of the spin coated mixture NbO—SnO₂\TiO₂ 25/75%+NbO-A after soft-bake at 100° C. for 1 min. Trench width is 114 nm (FIG. 18A) and 131 nm (FIG. 18B).

In FIG. 18A the two trenches on the right are filled almost to the top of the trench. However, wider gaps of >130 nm shown in FIG. 12B were not completely filled.

A sample that was made with two layers (with no soft-bake between the layers) and a soft-bake after the second layer and a hard-bake at 300° C. is shown FIG. 18C. As can be seen the gap remained filled, and no voids are present.

TABLE 13
Ellipsometry data for Examples T1-T5.

| | | Thick- | N @ | K @ |
|---|---|---|---|---|
| Example | | ness | 520 | 460 |
| # | Material | [nm] | nm | nm |
| T1 | PW-SnO₂ (Example 1) | | 1.804 | 0.0021 |
| T2-A | PW-SnO₂ (Example 1) + | | | |
| | BYK348 (0.5 wt %) | | | |
| T2-B | PW-SnO₂ (8.5 wt %) + | | | |
| | BYK348 (0.5 wt %) | | | |
| T2-C | NbO—SnO₂ (Example 2) + | | 1.767 | 0.0007 |
| | BYK348 | | | |
| T3 | PW-SnO₂ + PW-A | 66 | 1.912 | 0.01 |
| | (Example 2, weight ratio | | | |
| | 0.85/1) | | | |
| T4 | NbO—Sn_{.25}Ti_{.75}O₂ | NbO—A | 76.9 | 1.997 |
| | (Example 4) | | | |
| T5 | NbO—Sn_{.25}Ti_{.75}O₂ | NbO—A | 76.9 | 1.997 |
| | (Example 4) | | | |

1. A formulation for preparing an optical metal oxide layer, wherein the formulation comprises:
(i) a complex comprising
a polyoxometalate moiety represented by formula (Ia), and 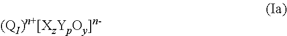
a nanoparticle represented by formula (Ib) 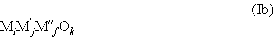
wherein
each Q independently represents a cation,
I is any number in the range from 1 to 20;
n is a number representing the total positive charge n+ of 1 cations Q and the corresponding negative charge n− of the polyanion [X_{z}YₚO_{y}];
X is a heteroatom;
Y is a metal;
z is 0 to 20; p is 1 to 100; and y is 2 to 400;
M, M′ and M,″ each independently, is a metal;
i, j, and f each independently, is an integer or a fraction of 0 to 10; with the proviso that at least one of i, j, and f is not 0; and
k is any number in the range of from 1 to 20; and
(ii) one or more formulation media.

2. The formulation according to claim 1, wherein the complex is not Na₇[PW₁₁O₃₉] complexed to TiO₂, Na₃[PMo₁₂O₄₀] complexed to TiO₂, K₆[P₂W₁₈O₆₂] complexed to TiO₂, K₆[P₂Mo₁₈O₆₂] complexed to TiO₂, or Q_{I} [SiW₁₁O₃₉] complexed to TiO₂.

3. The formulation according to claim 1, with the proviso that if formula Ib is TiO₂, formula Ia is not Na₇[PW₁₁O₃₉], Na₃[PMo₁₂O₄₀], K₆[P₂Mo₁₈O₆₂], K₆[P₂W₁₈O₆₂], or Q_{I} [SiW₁₁O₃₉].

4. The formulation according to claim 1, wherein the complex is represented by formula (I): 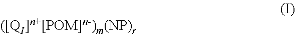
wherein
POM is a polyoxometalate represented by the formula (Ia);
NP is a metal oxide or mixed-metal oxide nanoparticle represented by formula (Ib);
m represents the number of polyoxometalate ligands per nanoparticle, and is any number in the range of from 1 to 5000; and
r is any number in the range from 1 to 20000 and represents an empirical metal-oxide unit in the nanoparticle.

5. The formulation according to claim 1, wherein M, M′, and M″, each independently, is Ba, Sr, Ti, Zr, Nb, Hf, Ta, Zn, Al, In, Sn, or Ce.

6. The formulation according to claim 1, wherein M′ is Ti and/or Mis Sn.

7. The formulation according to claim 1, wherein i is <1, j is 1−i, and f is 0.

8. The formulation according to claim 1, wherein the nanoparticle is SnO₂, CeO₂, ZrO₂, TiO₂, NbO₂, HfO₂, or Ta₂O₅.

9. The formulation according to claim 1, wherein X is P, Ar, Sb, S, Si, Ge, B, Be, Mg, Ca, Sr, Mn, Fe, Co, Ni, Cu, Zn, Al, Ga, or is absent.

10. The formulation according to claim 1, wherein Y is W, Nb, V, Ta, Ti, Zr, Hf, Mo, Zn, In, or Sn.

11. The formulation according to claim 1, wherein the polyoxometalate moiety is a heteropolyoxotungstate or a polyoxoniobate.

12. The formulation according to claim 1, wherein the formulation comprises (iii) one or more additive, wherein said one or more additive, each individually, is selected from the group consisting of a further complex as defined in claim 1, Na₃PW₁₂O₄₀*nH₂O, K₈NbO₁₉*nH₂O, a wetting agent, a dispersion agent, an adhesion promoter, a polymer matrix, and a surfactant.

13. The formulation according to claim 1, wherein the formulation further comprises Na₃PW₁₂O₄₀*nH₂O or K₈Nb₆O₁₉*nH₂O, and optionally a surfactant such as a polyether modified siloxane.

14. A method for preparing an optical metal oxide layer comprising the following steps:
(a) providing a formulation according to claim 1;
(b) applying the formulation to a surface of a substrate; and
(c) converting the formulation on the surface of the substrate to an optical metal oxide layer.

15. An optical device, comprising an optical metal oxide layer, wherein the layer is obtainable by a method according to claim 14.

16. A method for preparing an optical metal oxide layer or an optical device comprising using a formulation according to claim 1.

17. The formulation according to claim 1, wherein M, M′, and M″, each independently, is Ba(II), Sr(II), Ti(III), Ti(IV), Zr(IV), Nb(V), Nb(III), Hf(IV), Ta(V), Zn(II), Al(III), In(III), Sn(II), Sn(IV) or Ce(IV).

18. An augmented reality and/or virtual reality optical device, comprising an optical metal oxide layer, wherein the layer is obtainable by a method according to claim 14.
